(19) United States
(12) Patent Application Publication
(10) Pub. No.: US 2025/0280020 A1
(43) Pub. Date: Sep. 4, 2025

(54) Tracking threat actors across cloud identities

(71) Applicant: Sophos Limited, Abingdon (GB)

(72) Inventor: Arun Singh, Somerville, MA (US)

(21) Appl. No.: 19/067,956

(22) Filed: Mar. 2, 2025

(30) Foreign Application Priority Data
Mar. 2, 2024 (IN) 202411015617

(51) Int. Cl. H04L 9/40

(52) U.S. Cl. CPC H04L 63/1425

(57) ABSTRACT

A variety of techniques are used to locate and characterize relationships among user identities in a cloud computing environment, and to create a persistent database of identity mappings. The resulting identity mapping database can enable improved threat detection in the cloud computing environment, particularly in cases where an attack might otherwise be obscured as a number of low-severity detections associated with different entities. For example, the identity mapping database can facilitate threat scoring for a group of related entities and the detection of attacks that are coordinated among two or more such identities. The identity mapping database may also or instead be used to identify an attacker that hides an attack by switching identities during the attack.

### RELATED APPLICATIONS

This application claims priority to Indian Prov. patent application No. 202411015617, filed on Mar. 2, 2024, the entire content of which is hereby incorporated by reference.

### BACKGROUND

While cloud computing environments typically provide logging and publication of various activities for external consumption, the structure and timeliness of this data feed can make it difficult to quickly and accurately detect complex and/or slow-developing malicious activity in the cloud computing environment from an external resource such as a remote threat management facility. There remains a need for improved methods to detect malicious activity in cloud computing environments that host resources for an enterprise network.

### SUMMARY

A variety of techniques are used to locate and characterize relationships among user identities in a cloud computing environment, and to create a persistent database of identity mappings. The resulting identity mapping database can enable improved threat detection in the cloud computing environment, particularly in cases where an attack might otherwise be obscured as a number of low-severity detections associated with different entities. For example, the identity mapping database can facilitate threat scoring for a group of related entities and the detection of attacks that are coordinated among two or more such identities. The identity mapping database may also or instead be used to identify an attacker that hides an attack by switching identities during the attack.

In one aspect, a computer program product described herein includes computer executable code stored in a non-transitory computer readable medium that, when executing on one or more computing devices, causes the one or more computing devices to perform the steps of: identifying a first group of related identities in a plurality of identities for a cloud computing environment that are controlled by a single entity, wherein identifying the first group may include using audit logs that provide information regarding one of the identities of the plurality of identities that performed an action to create or affect another one of the identities of the plurality of identities in the cloud computing platform; identifying a second group of related identities in the plurality of identities controlled by the single entity using an application programming interface for the cloud computing environment to fetch resource properties and scan the resource properties for user credentials; identifying a third group of related identities in the plurality of identities controlled by the single entity by scanning files with a workload running on cloud instances in the cloud computing environment to locate hard-coded credentials; storing the first group of related identities, the second group of related identities, and the third group of related identities in an identity mapping database for the cloud computing environment, the identity mapping database identifying each of the plurality of identities controlled by the single entity; and calculating a threat score for a first one of the plurality of identities controlled by the single entity based on threat data for each other one of the plurality of identities associated with the single entity in the identity mapping database.

Calculating the threat score may include calculating the threat score as a joint probability of a first entity threat score for the one of the plurality of identities and one or more other entity threat scores for each other one of the plurality of identities related to the one of the plurality of identities in the identity mapping database. Each record in the identity mapping database may include a time, a type, an actor identity, and an affected identity. An action between a pair of related identities detected based on audit logs may be stored in the identity mapping database as a record of an identity action event including a time of the action, a type of the action, a first identity causing the action, and a second identity affected by the action. Each read event between a pair of related identities detected based on user credentials in the resource properties may be stored in the identity mapping database as a record of a credential read event including a time of the read event, a type of the read event, a first identity initiating the read event, a second identity affected by the read event. Each pair of related identities detected based on hard-coded credentials identified by the workload may be stored as a record including a time of discovery of the hard-coded credentials, a type of access by the workload, an actor identity having access to the workload, and an affected identity associated with the hard-coded credentials.

In another aspect, a method disclosed herein includes generating an identity mapping database that maps a plurality of identities in a cloud computing environment to a single entity, wherein the identity mapping database may be generated based on: audit logs of actions between identities in the cloud computing environment, resource properties fetched through an application programming interface for the cloud computing environment, and hard-coded credentials located on cloud instances in the cloud computing environment; and calculating a threat score for a first identity of the plurality of identities controlled by the single entity based on threat data for each one of the plurality of identities associated with the single entity in the identity mapping database.

The method may include storing threat data for the plurality of identities in an evidence table including one or more records, wherein each of the one or more records in the evidence table may include an identifier for one of the plurality of identities associated with a corresponding item of threat data in the record. Each of the one or more records in the evidence table may include an expiration time after which the record may be excluded from threat scoring for a corresponding one of the plurality of identities. The method may include calculating the threat score as a joint probability of a first entity threat score for the first identity of the plurality of identities, and one or more other entity threat scores for each other one of the plurality of identities related to the first identity in the identity mapping database. The method may include identifying the hard-coded credentials by scanning one or more files with a workload running on cloud instances in the cloud computing environment to locate hard-coded credentials in the one or more files for one or more of the plurality of identities. The workload may include an executable in a Windows environment. The workload may include a virtual machine, a serverless machine, or a container in a Linux environment. The identity mapping database may include one or more records, each of the one or more records including a time, a type, an actor identity, and an affected identity. An action between a pair of the identities detected based on the audit logs may be stored in the identity mapping database as a record of an identity action event including a time of the action, a type of the action, a first one of the pair of identities causing the action, and a second one of the pair of identities affected by the action. A read event detected between a pair of identities based on user credentials in the resource properties may be stored in the identity mapping database as a record of a credential read event including a time of the read event, a type of the read event, and a first one of the pair of identities initiating the read event, a second one of the pair of identities affected by the read event. A pair of the identities detected based on the hard-coded credentials may be stored in the identity mapping database as a record including a time of discovery of the hard-coded credentials, a type of access by a workload detecting the hard-coded credentials, an actor identity having access to the workload, and an affected identity associated with the hard-coded credentials.

In another aspect, a system described herein includes a memory storing an identity mapping database for a cloud computing environment that may include a plurality of identities, wherein: the identity mapping database identifies related identities, from among the plurality of identities, controlled by a single entity in the cloud computing environment, one or more related identities in the identity mapping database are identified using audit logs for the cloud computing environment that provide information regarding an identity in the cloud computing environment that performed an action to create or affect another identity in the cloud computing environment, one or more related identities in the identity mapping database are identified using an application programming interface for the cloud computing environment to fetch resource properties and scan the resource properties for user credentials, and one or more related identities in the identity mapping database are identified by scanning files for hard-coded credentials with a workload running on cloud instances in the cloud computing environment; and a threat detection module executing on a processor, the threat detection module configured by computer executable code to calculate a threat score for one of the plurality of identities based on threat data for one or more of the plurality of identities related to the one of the plurality of identities in the identity mapping database.

The threat score may be calculated as a joint probability of a first entity threat score for the one of the plurality of identities and one or more other entity threat scores for each of the one or more of the plurality of identities related to the one of the plurality of identities in the identity mapping database. Each record in the identity mapping database may include a time, a type, an actor identity, and an affected identity.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 depicts a block diagram of a threat management system.

FIG. 2 depicts a block diagram of a computer system.

FIG. 3 shows a system for enterprise network threat detection.

FIG. 4 illustrates a threat management system.

FIG. 5 illustrates a scoring method for generating threat detections in a cloud computing environment.

FIG. 6 illustrates a graph of compromisable entities in an enterprise network.

FIG. 7 illustrates a calculation of the inherent probability of compromise for entry nodes in a cloud computing environment.

FIG. 8 illustrates a graph of a cloud computing environment with entry nodes and internal nodes.

FIG. 9 illustrates a calculation of a probability of compromise for a node in a cloud computing environment.

FIG. 10 shows a graph for a cloud computing environment.

FIG. 11 illustrates a method for compound threat detection.

FIG. 12 is a flow chart of a method for compound threat detection.

FIG. 13 illustrates a method for rapid exposure detections.

FIG. 14 is a flow chart of a method for rapid exposure detections in a cloud computing environment.

FIG. 15 illustrates threat tracking across multiple identities in a cloud computing environment.

FIG. 16 illustrates threat tracking across multiple identities in a cloud computing environment.

FIG. 17 illustrates a technique for using an identity mapping database to detect threats in a cloud computing environment.

FIG. 18 is a flow chart of a method for tracking threat actors across cloud identities.

FIG. 19 illustrates a technique for threat detection using an evidence table with expiration times.

FIG. 20 is a flow chart of a method for detecting persistent attacks in cloud computing environments.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

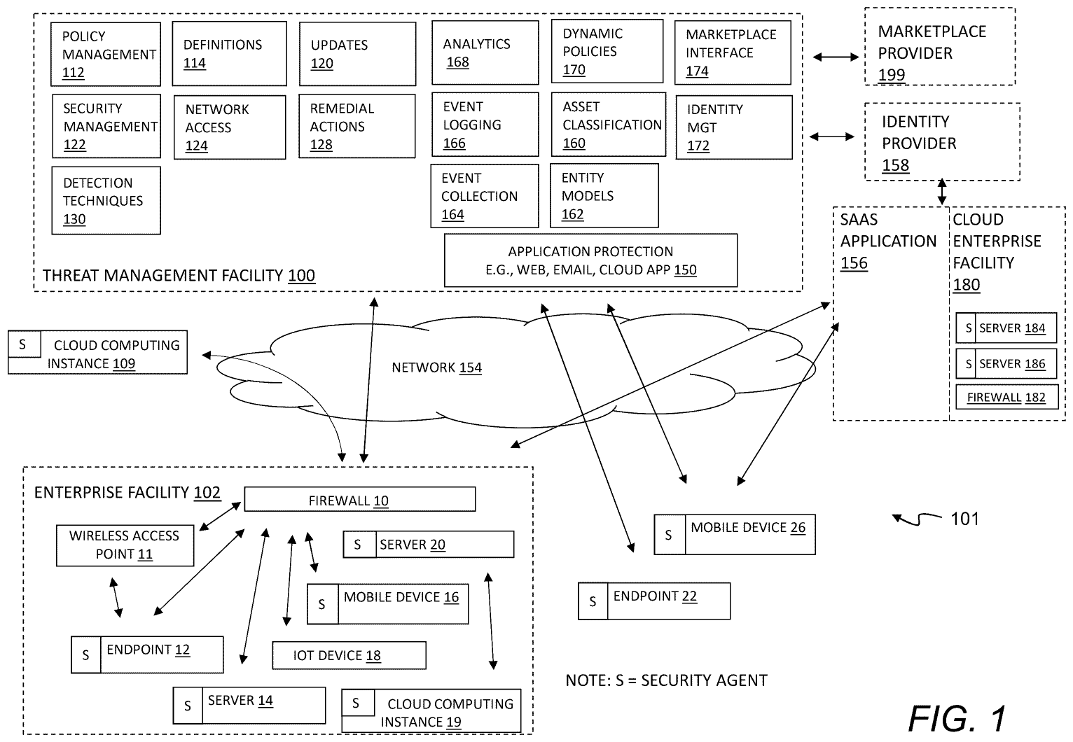

FIG. 1 depicts a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications, and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, an exemplary enterprise facility 102 may be or may include any networked computer-based infrastructure. For example, the enterprise facility 102 may be corporate, commercial, organizational, educational, governmental, or the like. As home networks get more complicated and include more compute instances at home and in the cloud, an enterprise facility 102 may also or instead include a personal network such as a home or a group of homes. A computer network for the enterprise facility 102 may be distributed amongst a plurality of physical premises such as buildings on a campus and located in one or in a plurality of geographical locations. The configuration of the enterprise facility as shown is merely exemplary, and it will be understood that there may be any number of compute instances, less or more of each type of compute instances, and other types of compute instances. As shown, the exemplary enterprise facility includes a firewall 10, a wireless access point 11, an endpoint 12, a server 14, a mobile device 16, an appliance or IoT device 18, a cloud computing instance 19, and a server 20. Again, the compute instances 10-20 depicted are exemplary, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policy facility 170, identity management facility 172, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, the threat management facility 100 may include, or may be connected to a security agent S such as a local security agent deployed on one or more other entities within the threat management system 101. The facilities of the threat management facility 100, and/or a security agent S therefore, may be deployed on the same physical hardware or logical resource as a gateway for an enterprise facility 102, a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace management facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to access a SaaS application 156. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of an application protection facility 150 provided by the cloud, and so on.

In an embodiment, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of an application protection facility 150 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of an application protection facility 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of an application protection facility 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of an application protection facility 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of an application protection facility 150 provided by the cloud, and so on. In embodiments, some reputation information may be stored on a compute instance 10-26, and other reputation data available through cloud lookups to an application protection lookup database, such as may be provided by an application protection facility 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the prevention of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 90 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to a network for the enterprise facility 102, where one or more compute instances on the network of the enterprise facility 102 may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a blacklist, an allowed list, a whitelist, and more. As a few non-limiting examples, policies may include a list of external network locations/applications for the enterprise facility 102 that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions but may otherwise preserve network bandwidth for other activities by restricting the use of IM to personnel that need access for a specific purpose. In an embodiment, the policy management facility 112 may be a stand-alone application, or may be part of the threat management facility 100, the cloud enterprise facility 180, the enterprise facility, or any suitable combination of these.

The policy management facility 112 may include dynamic policies that use contextual or other information to make security decisions. As described herein, the dynamic policy facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 9, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of an application protection facility 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 92 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 92 and policy management facility 112 may push information to the enterprise facility 102 network and/or the compute instances 10-26, the enterprise facility 102 network and/or compute instances 10-26 may pull information from the security facility 92 and policy management facility 112, or there may be a combination of pushing and pulling of information. For example, the enterprise facility 102 network and/or compute instances 10-26 may pull update information from the security facility 92 and policy management facility 112 via the update facility 120, an update request may be based on a time period, by a certain time, by a date, on demand, or the like. In another example, the security facility 92 and policy management facility 112 may push the information to the network and/or compute instances 10-26 of enterprise facility 102 by providing notification that there are updates available for download and/or transmitting the information. In an embodiment, the policy management facility 112 and the security facility 92 may work in concert with the update management facility 90 to provide information to the network and/or compute instances 10-26 of the enterprise facility 102. In various embodiments, policy updates, security updates and other updates may be provided by the same or different modules, which may be the same or separate from a security agent running on one of the compute instances 10-26.

As threats are identified and characterized, the definitions facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120 and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 94 may restrict access to certain applications, networks, files, printers, servers, databases, and so on. In addition, the network access facility 94 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 94 may determine if a given compute instance 10-22 should be granted access to a requested network location, e.g., inside or outside of the enterprise facility 102. Network access facility 94 may determine if a compute instance 22, 26 such as a device outside the enterprise facility 102 may access the enterprise facility 102. For example, in some cases, the policies may require that when certain policy violations are detected, certain network access is denied. The network access facility 94 may communicate remedial actions that are necessary or helpful to bring a device back into compliance with policy as described below with respect to the remedial action facility 128. Aspects of the network access facility 94 may be provided, for example, in the security agent of the endpoint 12, in a wireless access point 11, in a firewall 10, as part of an application protection facility 150 provided by the cloud, and so on.

In an embodiment, the network access facility 94 may have access to policies that include one or more of a block list, an allowed list, an unacceptable network site database, an acceptable network site database, a network site reputation database, or the like of network access locations that may or may not be accessed by the client facility. Additionally, the network access facility 94 may use rule evaluation to parse network access requests and apply policies. The network access rule facility 94 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include an entity model facility 162. Entity models supported by the entity model facility 162 may be used, for example, to determine the events that are generated by assets. For example, some operating systems may provide useful information for detecting or identifying events. For example, operating systems may provide process and usage information that is accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, cloud computing instance 19, and cloud compute instance 109. Events may range in granularity. An exemplary event may be communication of a specific packet over the network. Another exemplary event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility. Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 92 may take any steps or deploy any measures suitable for addressing a detection of a threat, potential threat, policy violation or other event, code or activity that might compromise security of a computing instance 10-26 or the enterprise facility 102.

A cloud enterprise facility 180 may include servers 184, 186, and a firewall 182. The servers 184, 186 on the cloud enterprise facility 180 may run one or more enterprise applications and make them available to the enterprise facilities 102 compute instances 10-26. It should be understood that there may be any number of servers 184, 186 and firewalls 182, as well as other compute instances in a given cloud enterprise facility 180.

In some implementations, the cloud enterprise facility 180 may include resources used by, but not managed by, the enterprise facility 102. For example, the threat management system 101 may include a Software-as-a-Service (SaaS) application 156 that is used by, but not operated by, the enterprise facility 102. Exemplary commercially available SaaS applications include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with the SaaS application 156, and/or an unprotected server (not shown) for the SaaS application 156 such as a web site or a third-party application through an internetwork 154 such as the Internet or any other public network, private network, or combination of these.

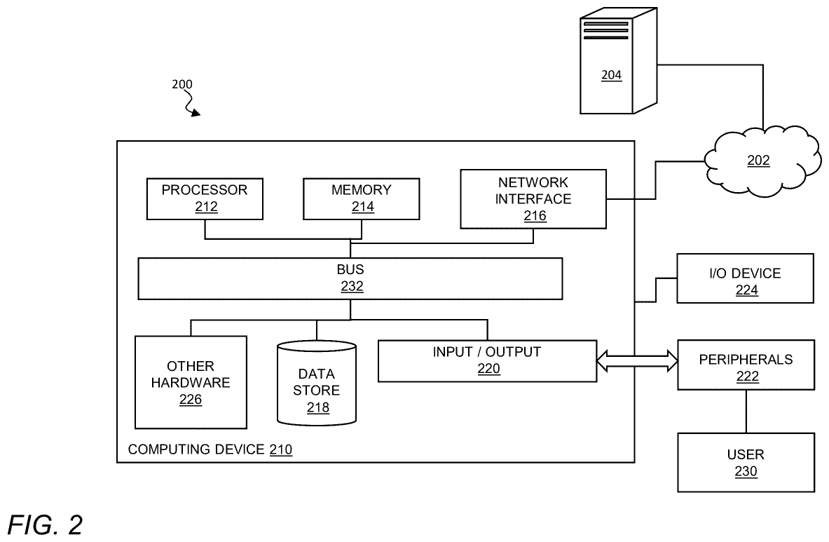

FIG. 2 depicts a block diagram of a computer system for use in the methods and systems described herein. In general, the computing system 200 of FIG. 2 may be, or may host or otherwise support, any of the components described herein, such as and without limitation, an endpoint, network device, data classification system, enterprise resource, threat management facility, identity provider, hardware security system, and the like.

The computer system 200 may include a computing device 210 connected to a network 202, e.g., for accessing an external device 204. The computing device 210 may be or include any type of network endpoint or endpoints as described herein. For example, the computing device 210 may include a desktop computer workstation. The computing device 210 may also or instead be any other device that has a processor and communicates over a network 202, including without limitation a laptop computer, a desktop computer, a personal digital assistant, a tablet, a mobile phone, a television, a set top box, a wearable computer, and so forth. The computing device 210 may also or instead include a server, or it may be disposed on a server or within a virtual or physical server farm. In certain aspects, the computing device 210 may be implemented as a set of hardware components for executing software. The computing device 210 may be a standalone device, a device integrated into another entity or device, or may be distributed across multiple entities.

The network 202 may include any network or combination of networks, such as one or more data networks or internetworks suitable for communicating data and control information among participants in the computer system 200. The network 202 may include public networks such as the Internet, private networks, and telecommunications networks such as the Public Switched Telephone Network or cellular networks using third generation cellular technology (e.g., 3G or IMT-2000), fourth/fifth generation cellular technology (e.g., 4G, LTE, MT-Advanced, E-UTRA, 5G, etc.) or WiMax-Advanced (IEEE 802.16m)) and/or other technologies, as well as any of a variety of corporate area, metropolitan area, campus, or other local area networks or enterprise networks, along with any switches, routers, hubs, gateways, and the like that might be used to carry data among participants in the computer system 200. The network 202 may also include a combination of data networks, and need not be limited to a strictly public or private network. Embodiments of the network 202 may include one or more enterprise networks as described herein.

The external device 204 may be any computer or other remote resource that connects to the computing device 210 through the network 202. This may include threat management resources such as any of those contemplated above, gateways or other network devices, remote servers or the like containing content requested by the computing device 210, a network storage device or resource, a device hosting content, or any other resource or device that might connect to the computing device 210 through the network 202.

The computing device 210 may include a processor 212, a memory 214, a network interface 216, a data store 218, and one or more input/output devices 220. The computing device 210 may further include or be in communication with one or more peripherals 222 and other external input/output devices 224.

The processor 212 may be any as described herein, and in general may be capable of processing instructions for execution within the computing device 210 or computer system 200. In one aspect, the processor 212 may be capable of processing instructions stored in the memory 214 or on the data store 218.

The memory 214 may store information within the computing device 210 or computer system 200. The memory 214 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down, and a second memory such as a random-access memory may provide volatile (but higher speed) memory for storing instructions and data for executing processes.

The network interface 216 may include any hardware and/or software for connecting the computing device 210 in a communicating relationship with other resources through the network 202. This may include connections to resources such as remote resources accessible through the Internet, as well as local resources available using short range communications protocols using, e.g., physical connections (e.g., Ethernet), radio frequency communications (e.g., WiFi or Bluetooth), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like. More generally, the network interface 216 may include any combination of hardware and software suitable for coupling the components of the computing device 210 to other platforms, computing or communications resources, and so forth.

The data store 218 may be any internal memory store providing a computer-readable medium such as a disk drive, an optical drive, a magnetic drive, a flash drive, memory card, or other device capable of providing mass storage for the computing device 210. The data store 218 may store computer readable instructions, data structures, program modules, and other data for the computing device 210 or computer system 200 in a non-volatile form for subsequent retrieval and use. The data store 218 may store computer executable code for an operating system, application programs, and other program modules, software objects, libraries, executables, and the like. The data store 218 may also store program data, databases, files, media, and so forth.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices.

The peripherals 222 may include any device or combination of devices used to provide information to or receive information from the computing device 210. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset, or any other audiovisual device for presenting information to a user or otherwise providing machine-usable or human-usable output from the computing device 210. The peripheral 222 may also or instead include a digital signal processing device, an actuator, or other device to support control of or communication with other devices or components.

Other hardware 226 may be incorporated into the computing device 210 such as a co-processor, a digital signal processing system, a math co-processor, a graphics engine, a video driver, and so forth. The other hardware 226 may also or instead include expanded input/output ports, extra memory, additional drives (e.g., a DVD drive or other accessory), and so forth.

A bus 232 or combination of busses may serve as an electromechanical platform for interconnecting components of the computing device 210 such as the processor 212, memory 214, network interface 216, other hardware 226, data store 218, and input/output interface 220. As shown in the figure, each of the components of the computing device 210 may be interconnected using a system bus 232 or other communication mechanism for communicating information.

Methods and systems described herein can be realized using the processor 212 of the computer system 200 to execute one or more sequences of instructions contained in the memory 214 to perform predetermined tasks. In embodiments, the computing device 210 may be deployed as a number of parallel processing systems coordinated to execute code together for improved performance. Instances of the computing device 210 may be realized in a virtualized environment where software on a hypervisor or other virtualization management facility emulates components of the computing device 210 as appropriate to reproduce some or all of the functions of a hardware instantiation of the computing device 210.

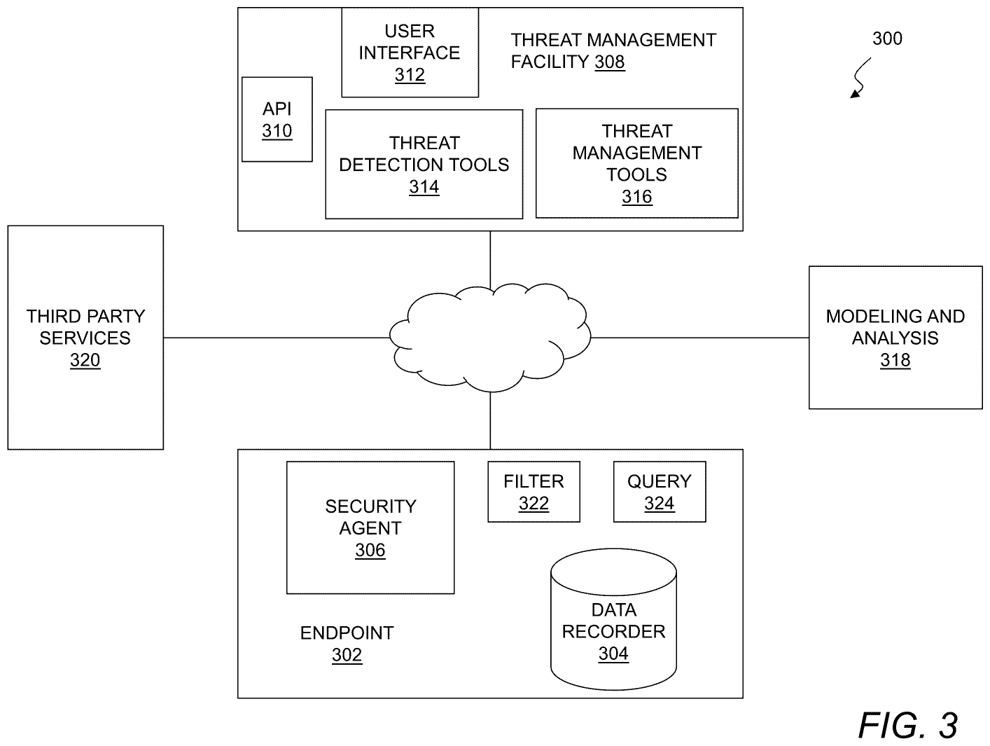

FIG. 3 shows a system 300 for enterprise network threat detection. The system 300 may use any of the various tools and techniques for threat management contemplated herein. In the system, a number of endpoints such as the endpoint 302 may log events in a data recorder 304. A local agent on the endpoint 302 such as the security agent 306 may filter this data and feed a filtered data stream to a threat management facility 308 such as a central threat management facility or any of the other threat management facilities described herein. The threat management facility 308 may locally or globally tune filtering by local agents based on the current data stream and may query local event data recorders for additional information where necessary or helpful in threat detection or forensic analysis. The threat management facility 308 may also or instead store and deploys a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 308 may provide any of a variety of threat management tools 316 to aid in the detection, evaluation, and remediation of threats or potential threats.

The threat management facility 308 may perform a range of threat management functions such as any of those described herein. The threat management facility 308 may generally include an application programming interface 310 to third party services 320, a user interface 312 for access to threat management and network administration functions, and a number of threat detection tools 314.

In general, the application programming interface 310 may support programmatic connections with third party services 320. The application programming interface 310 may, for example, connect to Active Directory or other customer information about files, data storage, identities and user profiles, roles, access privileges and so forth. More generally the application programming interface 310 may provide a programmatic interface for customers or other third party context, information, administration and security tools, and so forth. The application programming interface 310 may also or instead provide a programmatic interface for hosted applications, identity provider integration tools or services, and so forth.

The user interface 312 may include a website or other graphical interface or the like and may generally provide an interface for user interaction with the threat management facility 308, e.g., for threat detection, network administration, audit, configuration and so forth. This user interface 312 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

The threat detection tools 314 may be any of the threat detection tools, algorithms, techniques or the like described herein, or any other tools or the like useful for detecting threats or potential threats within an enterprise network. This may, for example, include signature based tools, behavioral tools, machine learning models, and so forth. In general, the threat detection tools 314 may use event data provided by endpoints within the enterprise network, as well as any other available context such as network activity, heartbeats, and so forth to detect malicious software or potentially unsafe conditions for a network or endpoints connected to the network. In one aspect, the threat detection tools 314 may usefully integrate event data from a number of endpoints (including, e.g., network components such as gateways, routers, and firewalls) for improved threat detection in the context of complex or distributed threats. The threat detection tools 314 may also or instead include tools for reporting to a separate modeling and analysis platform 318, e.g., to support further investigation of security issues, creation or refinement of threat detection models or algorithms, review and analysis of security breaches, and so forth.

The threat management tools 316 may generally be used to manage or remediate threats to the enterprise network that have been identified with the threat detection tools 314 or otherwise. Threat management tools 316 may, for example, include tools for sandboxing, quarantining, removing, or otherwise remediating or managing malicious code or malicious activity, e.g., using any of the techniques described herein.

The endpoint 302 may be any of the endpoints or other compute instances or the like described herein. This may, for example, include end-user computing devices, mobile devices, firewalls, gateways, servers, routers and any other computing devices or instances that might connect to an enterprise network. As described above, the endpoint 302 may generally include a security agent 306 that locally supports threat management on the endpoint 302, such as by monitoring for malicious activity, managing security components on the endpoint 302, maintaining policy compliance, and communicating with the threat management facility 308 to support integrated security protection as contemplated herein. The security agent 306 may, for example, coordinate instrumentation of the endpoint 302 to detect various event types involving various computing objects on the endpoint 302, and supervise logging of events in a data recorder 304. The security agent 306 may also or instead scan computing objects such as electronic communications or files, monitor the behavior of computing objects such as executables, and so forth. The security agent 306 may, for example, apply signature-based or behavioral threat detection techniques, machine learning models (e.g. models developed by the modeling and analysis platform), or any other tools or the like suitable for detecting malware or potential malware on the endpoint 302.

The data recorder 304 may log events occurring on or related to the endpoint. This may, for example, include events associated with computing objects on the endpoint 302 such as file manipulations, software installations, and so forth. This may also or instead include activities directed from the endpoint 302, such as requests for content from Uniform Resource Locators or other network activity involving remote resources. The data recorder 304 may record data at any frequency and any level of granularity consistent with proper operation of the endpoint 302 in an intended or desired manner.

The endpoint 302 may include a filter 322 to manage a flow of information from the data recorder 304 to a remote resource such as the threat detection tools 314 of the threat management facility 308. In this manner, a detailed log of events may be maintained locally on each endpoint, while network resources may be conserved for reporting of a filtered event stream that contains information believed to be most relevant to threat detection. The filter 322 may also or instead be configured to report causal information that causally relates collections of events to one another. In general, the filter 322 may be configurable so that, for example, the threat management facility 308 may increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 302 may include a query interface 324 so that remote resources such as the threat management facility 308 may query the data recorder 304 remotely for additional information. This may include a request for specific events, activity for specific computing objects, or events over a specific time frame, or some combination of these. Thus for example, the threat management facility 308 may request all changes to the registry of system information for the past forty eight hours, all files opened by system processes in the past day, all network connections or network communications within the past hour, or any other parametrized request for activities monitored by the data recorder 304. In another aspect, the entire data log, or the entire log over some predetermined window of time, may be requested for further analysis at a remote resource.

It will be appreciated that communications among third party services 320, a threat management facility 308, and one or more endpoints such as the endpoint 302 may be facilitated by using consistent naming conventions across products and machines. For example, the system 300 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, and endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

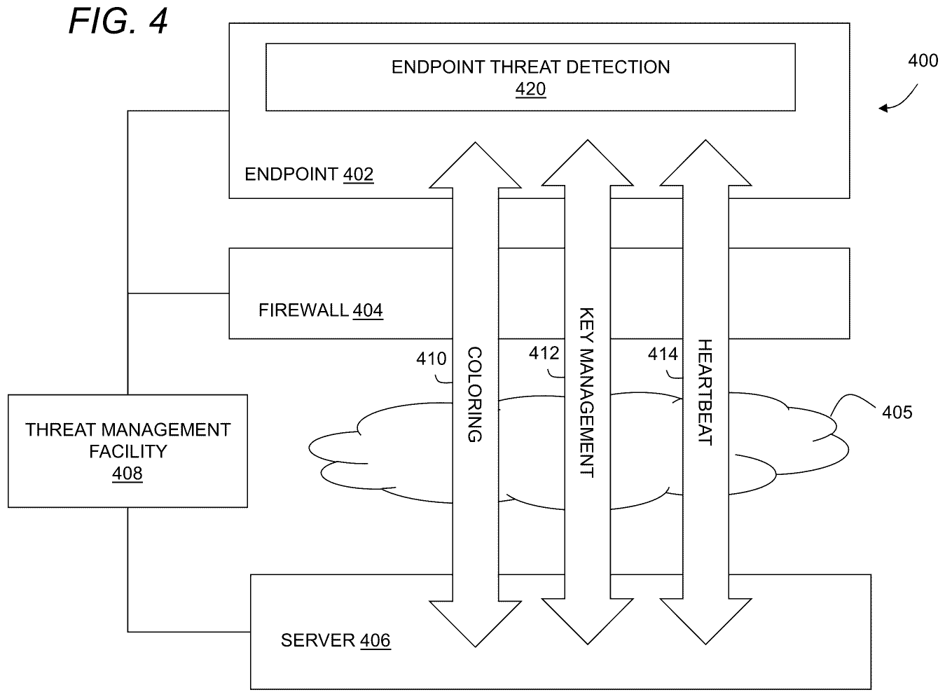

FIG. 4 illustrates a threat management system. In general, the system 400, which may be any of the enterprise networks and/or other networks or systems described herein, may include an endpoint 402, a firewall 404, a server 406 and a threat management facility 408 coupled to one another directly or indirectly through a data network 405, all as generally described above with reference to FIGS. 1-3. Each of the entities depicted in FIG. 4 may, for example, be implemented on one or more computing devices such as the computing devices described herein. A number of systems and subsystems may be distributed across these various components to support threat detection, such as a coloring system 410, a key management system 412 and a heartbeat system 414, each of which may include software components executing on any of the foregoing system components, and each of which may communicate with the threat management facility 408 and an endpoint threat detection agent 420 executing on the endpoint 402 to support improved threat detection and remediation.

The coloring system 410 may be used to label or color software objects for improved tracking and detection of potentially harmful activity. The coloring system 410 may, for example, label files, executables, processes, network communications, data sources and so forth with any suitable information. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 410 as contemplated herein.

The key management system 412 may support management of keys for the endpoint 402 in order to selectively permit or prevent access to content on the endpoint 402 on a file-specific basis, a process-specific basis, an application-specific basis, a user-specific basis, or any other suitable basis in order to prevent data leakage, and in order to support more fine-grained and immediate control over access to content on the endpoint 402 when a security compromise is detected. Thus, for example, if a particular process executing on the endpoint is compromised, or potentially compromised or otherwise under suspicion, keys to that process may be revoked in order to prevent, e.g., data leakage or other malicious activity.

The heartbeat system 414 may be used to provide periodic or aperiodic information from the endpoint 402 or other system components about system health, security, status, and so forth. A heartbeat may be encrypted or plaintext, or some combination of these, and may be communicated unidirectionally (e.g., from the endpoint 402 to the threat management facility 408) or bidirectionally (e.g., between the endpoint 402 and the server 406, or any other pair of system components) on any useful schedule.

In general, these various monitoring and management systems may cooperate to provide improved threat detection and response. For example, the coloring system 410 may be used to evaluate when a particular process is potentially opening inappropriate files based on an inconsistency or mismatch in colors, and a potential threat may be confirmed based on an interrupted heartbeat from the heartbeat system 414. The key management system 412 may then be deployed to revoke keys to the process so that no further files may be opened, deleted, or otherwise modified. More generally, the cooperation of these systems enables a wide variety of reactive measures that may improve detection and remediation of potential threats to an endpoint.

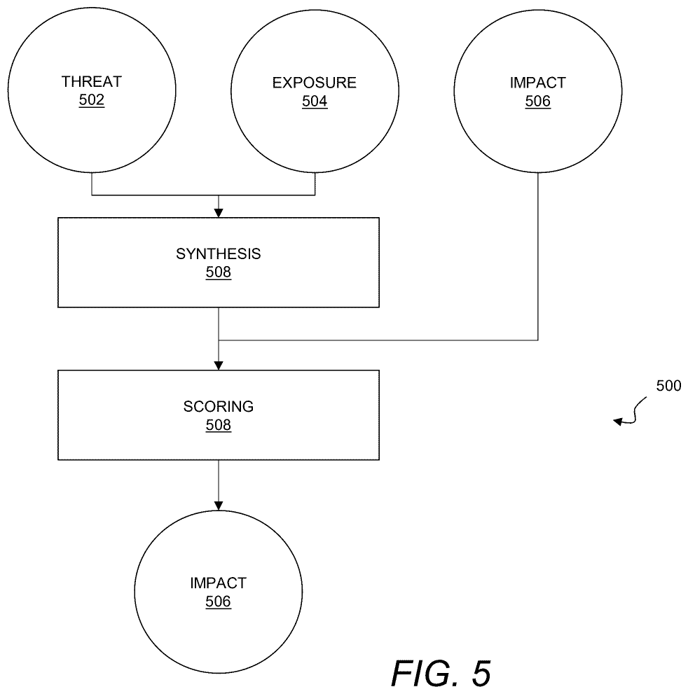

FIG. 5 illustrates a scoring method for generating threat detections in a cloud computing environment. In general, a graph of nodes represents entities in a cloud computing environment. Each one of the nodes of the graph can be characterized by inherent risks associated with known vulnerabilities and configuration details of the node, as well as a probability of exposure to other nodes based on access and control permissions for those other nodes connected to the node through the graph. In addition, the underlying value or sensitivity of data stored on the node may also be provided. With this data available as context, a probabilistic model for the relevance of threat evidence can then be derived from the graph and used to evaluate the overall riskiness or severity of accumulated evidence of threats to a node in the cloud computing environment. The graph of nodes, as further described herein, may be created using available node information for the cloud computing environment. The nodes can be interconnected in the graph by edges, each of which can be characterized by, e.g., access and control permissions between pairs of interconnected nodes. Using this graph, a probabilistic model for the relevance of threat evidence can then be derived and used to evaluate accumulated evidence of threats in the cloud computing environment.

In general, the scoring method 500 may be used to automatically correlate evidence from multiple sources available from the cloud computing environment, such as activity logs, traffic logs, and cloud resource configurations or other resource configuration data, and to present detections with the highest likelihood of compromise and/or the maximum impact. Conceptually, the available data may be quantitively evaluated with respect to threat 502, exposure 504, and impact 506. In this context, the threat 502 indicates a degree of threat based on observations available in an evidence table or other data source that stores event data for the cloud computing environment, the exposure 504 indicates a degree to which a particular node is vulnerable to malicious exploits, and the impact 506 indicates a value associated with data on a node. Data for the threat 502 and the exposure 504 may be synthesized for a group of nodes, e.g., based on the threat of each adjacent node and the access permissibility of a link to the node being scored. This synthesis 508 can provide an overall picture of the riskiness of the posture of a node, in view of its own vulnerabilities and the vulnerabilities of nodes that are actually or potentially coupled to the node. For example, this synthesis 508 may include a degree of thresholding to remove low relevance relationships and may be based on an inherent threat score of one of the nodes, and a probability weighted sum of contributions of inherent threat scores for other nodes connected to the nodes through the graph. Finally, a scoring 508 for an accumulation of threat data and exposure information can estimate the actual riskiness of accumulated evidence based on the underlying threat data (threat 502) and the riskiness of each node (exposure 504), as combined with the value of data on a node (impact 506). A wide range of techniques may be used to synthesize data in this manner, with a number of examples provided below.

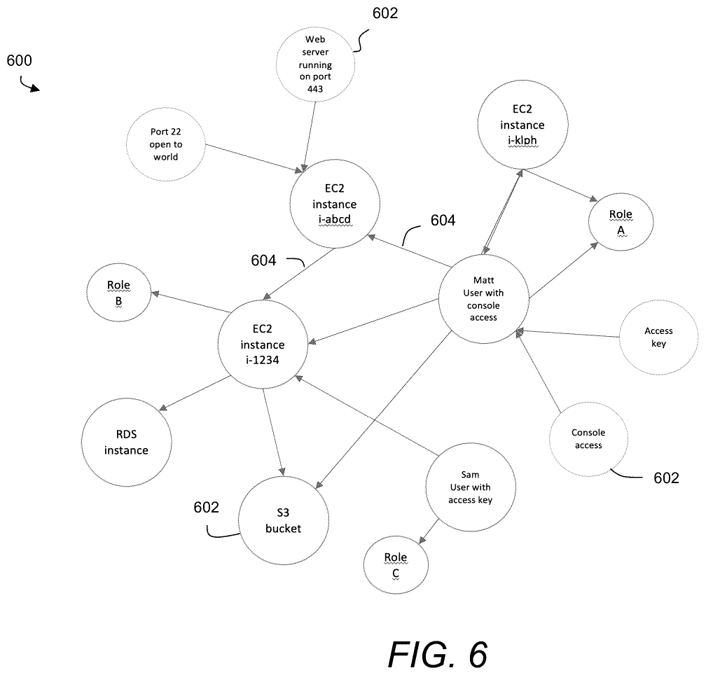

FIG. 6 illustrates a graph of compromisable entities in an enterprise network. As shown in FIG. 6, the graph 600 may be created for the cloud computing environment, and may include a number of nodes 602 each representing a compromisable entity within the cloud computing environment. In general, a compromisable entity may be any entity that provides a path of access into the cloud computing environment for an attacker. In one aspect, the compromisable entity may be a port that provides access to other resources. In another aspect, the compromisable entity may be a user or role within the cloud computing environment. The compromisable entity may also or instead be a cloud computing platform resource such as a Relational Database Service (RDS) instance, an Elastic Compute Cloud (EC2) instance, a Simple Storage Service (S3) instance, or any other compute instance, database, database server, web server, identity management service, or other resource within, or having access to, the cloud computing environment. In one aspect, a single cloud resource such as a compute instance or application may be a compromisable entity, or may have multiple compromisable entities based on, e.g., user identities, processes, and so forth.

The nodes 602 may be processed to create edges 604 corresponding to actual or potential connections between the nodes 602. For each one of the edges 604 between two nodes 602, an access level may be calculated that provides a quantitative indication of the degree of access by a first node to a second node. In general, the access level may be calculated in each direction according to the corresponding access level of a first node to a second node, and from the second node to the first node. The access level may be based on any indicia of access to a node, such as network access and permissions based access. The network access and permissions may then be used in turn to determine or calculate what type of actions an attacker can perform from a connecting node (the source for an exploit) on an affected node (the destination node of an exploit). Each connecting node can be used to exfiltrate data, to move laterally through the cloud computing environment, or to otherwise launch malicious activities depending on the permissibility of the edge between the affected node and the connecting node. The resultant graph 600 may capture relationships between some or all of the resources in a cloud computing environment for a customer and may be used by a threat management facility or other security resource to calculate exposure of each resource.

In one aspect, a threat analysis using the graph 600 may begin with a calculation of the inherent probability of exposure for each node. In one embodiment, the inherent probability of compromise of a node is the probability of compromise given no other node is connected to that node. If a node cannot be inherently compromised then a (non-zero) default probability of 0.01 may be assigned. Each misconfiguration of a node or known vulnerability of a node in the cloud computing environment may have an associated conditional probability of compromise of the node, P (C/Ei) (the probability of compromise of a particular resource, given evidence Ei of misconfiguration), which may be estimated, empirically calculated, or otherwise determined. For example, P (C/Ei) may be pre-defined by security engineers for each known misconfiguration or vulnerability depending on level of exposure and fed to the model.

For a resource in the cloud computing environment, as represented by a node in the graph 600, the inherent probability of compromise may be calculated as a joint probability of each evidence-based probability of compromise as follows:

$$P ( {E}_{1} , {E}_{2} , ... {E}_{n} ) = 1 - {∝}^{n - 1} * P ( ∼ {E}_{1} ) * P ( ∼ {E}_{2} ) ... P ( ∼ {E}_{n} )$$

where
Eₙ=evidence n (in evidence table)
P(˜Eₙ)=probability of compromise not happening given Eₙ
α=joint compromise coefficient

The joint compromise coefficient will be less than one and may be used to provide an adjustment factor for the joint effect of multiple vulnerabilities compared to vulnerabilities considered in isolation. Nodes 602 that are Internet-facing or that can otherwise be used by attackers to gain initial access in the environment (collectively referred to herein as entry nodes) may be scored first and then the graph may be traversed to calculate the probability of each node getting compromised based on total probability of all paths leading to the node from entry nodes.

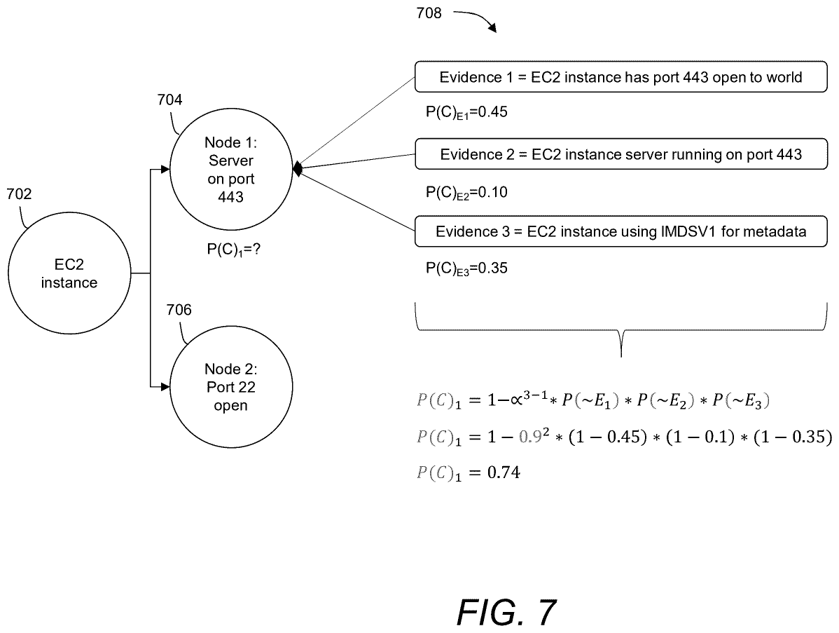

FIG. 7 illustrates a calculation of the inherent probability of compromise for entry nodes in a cloud computing environment. In this case, an elastic compute instance 702 may be represented as two compromisable entities (or corresponding nodes in a resource graph), a server 704 and an open port 706. An inherent probability of compromise, P(C)ₙ, for one of the compromisable entities, n, may be calculated based on available evidence 708 for that entity, e.g., as stored in an evidence table or other data structure for the cloud computing environment, and using the equation above. FIG. 7 more specifically illustrates a calculation of the inherent probability of compromise for the server 704, which yields a value of 0.74. A similar calculation may be performed for the open port 706, which is treated as a separate compromisable entity (and entry point) in the cloud computing environment. This calculation may be repeated as necessary for other entry points in the cloud computing environment.

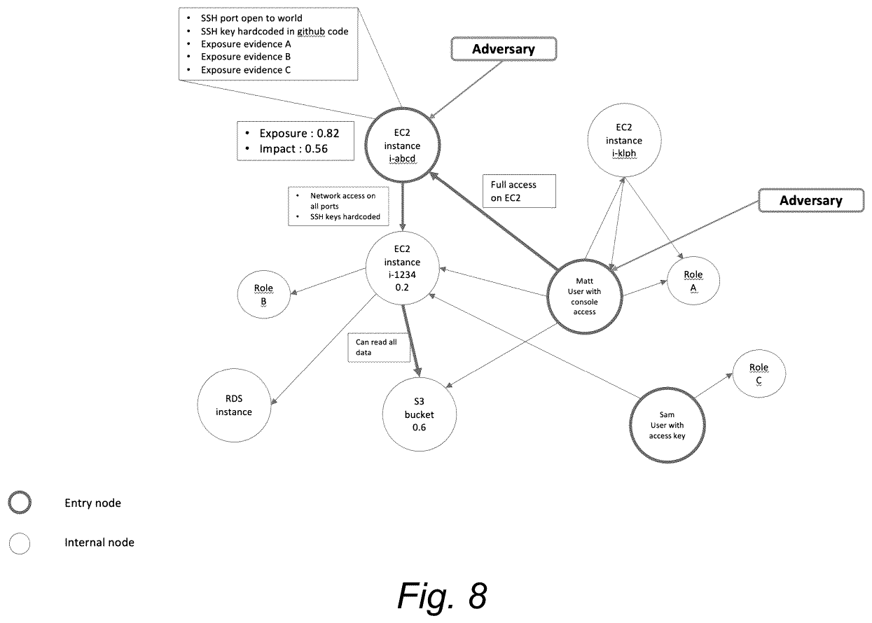

FIG. 8 illustrates a graph of a cloud computing environment with entry nodes and internal nodes. In this example, an attacker may gain access to EC2 instance i-abcd, then use hardcoded ssh keys and network access to gain access to instance i-1234, which in turn has read access on an S3 bucket and an RDS instance. An attacker may then be able to collect sensitive data from the S3 bucket and the RDS instance. Alternatively, the attacker may compromise user Matt and then follow any available path through the cloud computing environment (with different paths implying different tools and techniques for access) to access data stored in the RDS instance and the S3 bucket. In aspect, where user Matt has full access via a console to the EC2 instance i-abcd as shown in the figure, the user Matt may use that access along with any of the other exploits described herein to access the RDS instance or the S3 bucket.

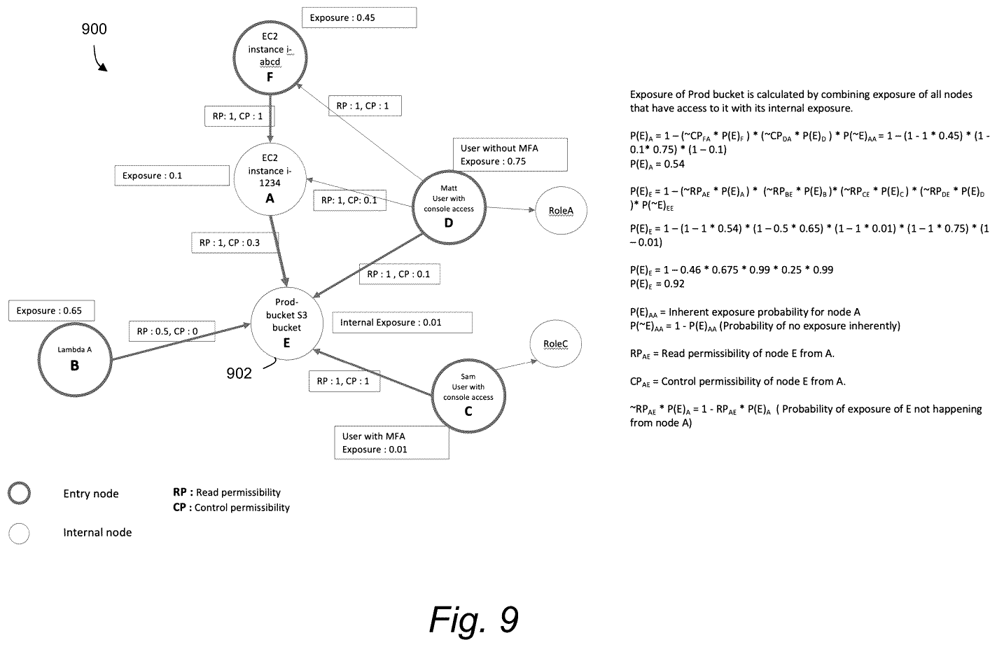

FIG. 9 illustrates a calculation of a probability of compromise for a node in a cloud computing environment. In general, a probability of compromise for a particular node, e.g., node E in the illustration, may be based on the inherent probability of compromise for connected nodes A, B, C, and D, along with a weighting for the contribution from each node based on an access level. Thus, in one aspect, the inherent probability of compromise may be precalculated for each node as described above. Access levels may also be assigned, indicative of the degree of access or control associated with an edge connecting one node to another. It will be understood that, while these access levels may be bidirectional, they are generally unidirectional because the access level from, say resource A to resource B will generally be different than the access level from resource B to resource A. In one aspect, these access levels may be scaled from 0 to 1, indicating a range from no access to full access, although other numerical scoring ranges and techniques, including multi-dimensional representations of access capabilities, may also or instead be used. In one aspect, the access level may be represented by a Read Permissibility (RP) indicating privileges to read data on the target node and a Control Permissibility (CP) indicating privileges or capabilities to control actions on the target node. In the figure a Read Permissibility and a Control Permissibility are illustrated for all edges between the nodes, generally representing access in the direction of a corresponding arrow in the figure.

RP may be a probability that generally represents the ability to read data from B once an attacker has control of A. RP may be calculated by processing specific or explicit read permissions between node A and node B. For example, if node A has read_all permissions on node B then RP may be 1, and if node A has no permissions on node B then RP may be 0. Values in between 0 and 1 may be calculated based on what type of resource B is and what read permissions are assigned. A low or zero value may be assigned to actual or possible permissions that do not expose any vulnerabilities. For example, for an S3 bucket, only “Read Files” and “List All Files” permissions might be considered sufficiently material to consider when calculating the RP.

CP may be a probability that generally represents the ability of the attacker to gain control of node B, given the attacker has control on node A. CP may be calculated based on a level of network access, authentication methods, permissions between node A and B, and so forth. If there are multiple direct paths to access node B from node A then a joint permissibility may be calculated in the same manner as calculating inherent compromise probability, i.e., as a joint conditional probability of all of the paths to access. In the example of FIG. 9, the probability of exposure of the S3 bucket 902 (node E) may be calculated by combining probabilities and permissibilities for the adjacent nodes, as illustrated in the figure.

The graph 900 may yield a probability of compromise or level of exposure associated with each node represented in the graph 900. In general, a higher probability of compromise calculated using the graph 900 will indicate a higher estimated level of exposure by a corresponding one of the nodes to malicious access. The graph 900 may be updated on an ongoing basis as configuration or vulnerability changes occur in the customer environment so that the graph 900 represents the latest exposure state of the cloud computing environment, e.g., when performing other threat calculations as described herein.

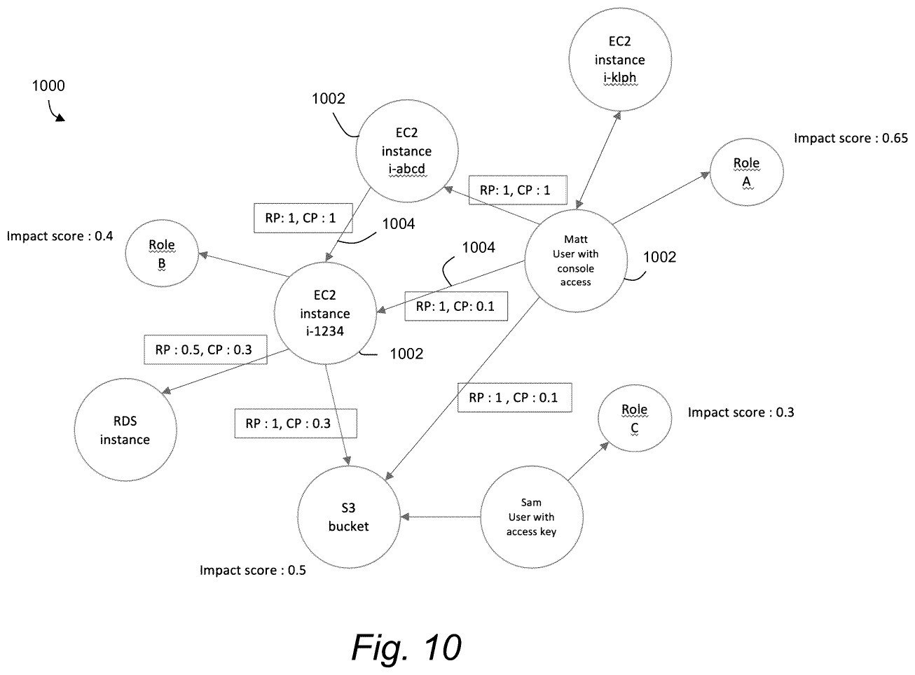

FIG. 10 shows a graph for a cloud computing environment. As shown in FIG. 10, the graph 1000 may be used to calculate an impact score that reflects the security risk (based on exposure) as well as the value of assets (e.g., data) on a node. The inherent impact of each of the nodes 1002 may be calculated, e.g., as described above. The inherent impact score may be calculated, e.g., based on the level of permissions a particular node has, the sensitivity of the data stored on the node, the economic or business value of the data, and so forth, and may be evaluated, e.g., with a score on a range of zero to one.

In one aspect, the impact score may be evaluated using a Breadth-first Search to traverse nodes 1002 in the graph 1000 starting with a designated node (e.g., a “root” node) and exploring neighboring nodes at a current depth level before moving on to nodes at the next level, where the current depth starts with immediate neighbors (at a depth level of one) before moving on to nodes that are two levels away. During this traversal, the impact score of a node may be calculated as the maximum of the current node, and nodes at the current level. The contributing nodes at the current level may be filtered using any suitable limits on exposure. For example, contributing nodes may be limited to nodes having a control permissibility greater than 0.5 along a connecting edge or a read permissibility greater than 0.5 along the connecting edge. Using a max function over this aggregation can advantageously avoid multiple resources with low impact from driving the impact score for a node toward the maximum value. The impact scoring for the graph 1000 of the cloud computing environment may be updated periodically, e.g., as configuration changes occur in the corresponding customer environment.

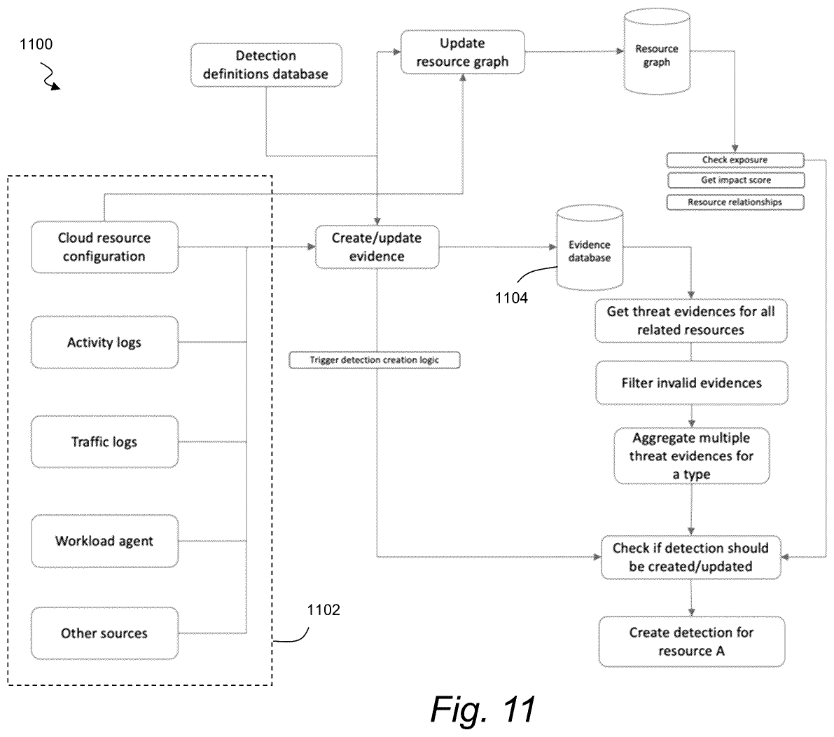

FIG. 11 illustrates a method for compound threat detection. In general, the method 1100 may begin with acquiring evidence for use in threat detection. Evidence may be acquired from multiple data sources 1102 such as cloud resource configuration data for the cloud computing environment, activity logs for computing activity within the cloud computing environment, traffic logs for communications within the cloud computing environment or with external resources, and one or more agents running inside cloud workloads for a customer in the cloud computing environment. The evidence accumulated from these data sources 1102 may provide evidence for evaluating threats, exposure, impact, and the like, and may be used update an evidence table 1104 (also referred to as an “evidence database”) and create scores and the like for evaluating potential threats based on predefined rules. Rules for processing evidence may be stored, e.g., in persistent storage for the cloud computing environment, or a threat management facility for the cloud computing environment and fetched by an evidence creator service at runtime.

The generated exposure and impact data stored in the evidence table 1104, referred to herein as “evidence,” may then be used as described herein to update a graph such as any of the resource graphs of cloud computing environments described herein. The resource configuration data may also be used to determine inter-resource access and dependencies. Each evidence creation may also be sent to a detection creation service (DCS) that processes each received evidence individually. For each new evidence received, the DCS may retrieve a list of all threat evidence from the evidence table for the resource (e.g., node in the graph) that the new evidence is associated with, as well as for related resources. This list of related resources may be fetched, for example, from the resource graph. This can help to identify instances where a single attacker uses multiple resources to carry out an attack, with any potentially relevant evidence gathered and presented to an analyst or other user.

The list of evidence may be time dated and/or provided with an expiration date for each entry so that the list of evidence can filtered and any old/invalid evidence can be removed, either automatically by the evidence table 1104, or using a background process, workload, or other computing resource to continuously review the evidence table 1104 and remove expired entries. An expiration time for each entry may be established, e.g., using predefined rules and the time at which an evidence occurred or was detected. The DCS may then calculate the threat score based on all threat evidence.

The DCS may also fetch an exposure score and an impact score for a resource from the resource graph and may combine this with a threat score as described herein to arrive at a final score indicative of the severity of a detected threat. The final score may be compared to a threshold that is used, e.g., to raise a detection, notify a user, and so forth, in which case the user may be provided with the final score, all evidence (either as raw data from the evidence table 1104, or in an interactive user interface or the like for user investigation), and any other suitable data such as contextual information, intermediate threat scores, some or all of the resource graph, and so forth. Threat evidence may be categorized between core evidence and associated evidence, where core evidence is evidence that strongly indicates compromise and thus is used as a part of the logic that creates a detection. Associated evidence may include weak indicators of compromise that are omitted from the threat detection logic but may nonetheless be provided to the user as context and included in the information accompanying a detection if/when one is created.

As described herein, a threat detection algorithm may continuously collect threat evidence and apply rules/logic to see if there is enough core evidence to raise a detection. Detections may be presented to users in descending order of severity. This ensures that at any given time the user is focusing on detection that poses the highest risk. The data gathering and scoring techniques described herein provide significant advantages over other threat detection methods known in the art. In one aspect, compound threat detection can mitigate or reduce detections with low signal-to-noise ratios. One aspect of threat detection in the cloud is identifying an adversary that has gained access to the customer cloud environment. There are many security tools that detect adversaries using activity logs generated by cloud providers, traffic logs, agents deployed on workloads, and so forth. However, most of these threat detection techniques based on activity in cloud computing environments are not deterministic, meaning they only imply presence of a threat with a certain confidence, because it can be difficult to differentiate between activity done by an adversary within the cloud computing environment and valid user activity within the cloud computing environment. Because of the non-deterministic nature of these detections, existing security tools typically limit detections to very strong signals of compromise or generate a lot of noise requiring human intervention and differentiation.

In one aspect, the compound threat detection techniques described herein can improve threat detection in a cloud computing environment by combining multiple threat detections (evidence) for a particular resource or group of resources to create compound detections and assigning conditional probability for each evidence so that a joint probability equation can be used to calculate the overall probability of compromise based on all correlated detections. A detection can then be raised once this joint probability crosses a certain threshold.

In another aspect, the compound threat detection techniques described herein can improve threat detection in a cloud computing environment by combining exposure likelihood with threat indicators. The threat algorithm can account for the greater risk of resources with higher exposure likelihood by creating a probabilistic model of compromise for all resources in the cloud computing environment based on their configurations and vulnerability data. The likelihood score can then be combined with a threat score when calculating a final risk score.

In another aspect, the compound threat detection techniques described herein can improve threat detection in a cloud computing environment by dividing threat evidence into two categories: core and associated evidence. This categorization can help to distinguish between evidence having a low signal to noise ratio and evidence having a high signal to noise ratio when evaluating overall risk.

In another aspect the compound threat detection techniques described herein can improve configurability according to customer needs. Cloud security has different meanings for different organizations. A threat that has a low severity for one organization might have critical severity for another. For example, an organization in which users work from home and use public Virtual Private Networks (VPNs) to access the cloud computing environment would not want critical detections on login anomaly as any security tool will raise a lot of false positives. By contrast, an organization that enforces strict access to cloud computing environments using fixed networks might want to be alerted as soon as there is a login anomaly alert. Organizations can range between the above to examples and thus require different levels of alerting on a customer-by-customer basis. Most security tools provide custom configuration of severity levels for their own individual detections, but compound detections heterogenous evidence from cloud computing resources generally lack this configurability, and cannot be tuned for sensitivity to false positives or missed detections for a particular customer. In another aspect the compound threat detection techniques described herein provides improved flexibility in compound detections where users can modify the inherent exposure/threat score of individual evidence, thus controlling how compound detections are raised.

In another aspect, cloud monitoring tools typically fail to provide a complete picture for correctly prioritizing the severity of detections. Existing threat tools assign a single score to a type of threat detection without considering context related to the resource. Because of an incomplete picture, users often prioritize detections that pose less risk to their cloud computing environment. The compound threat detection techniques described herein can address this difficulty by incorporating the impact of an individual resource being compromised so that a threat with even low likelihood is prioritized in those cases where it may have a high impact. The compound detection algorithm can also address exposure probability of each resource and use it to more accurately determine likelihood of compromise for a resource.

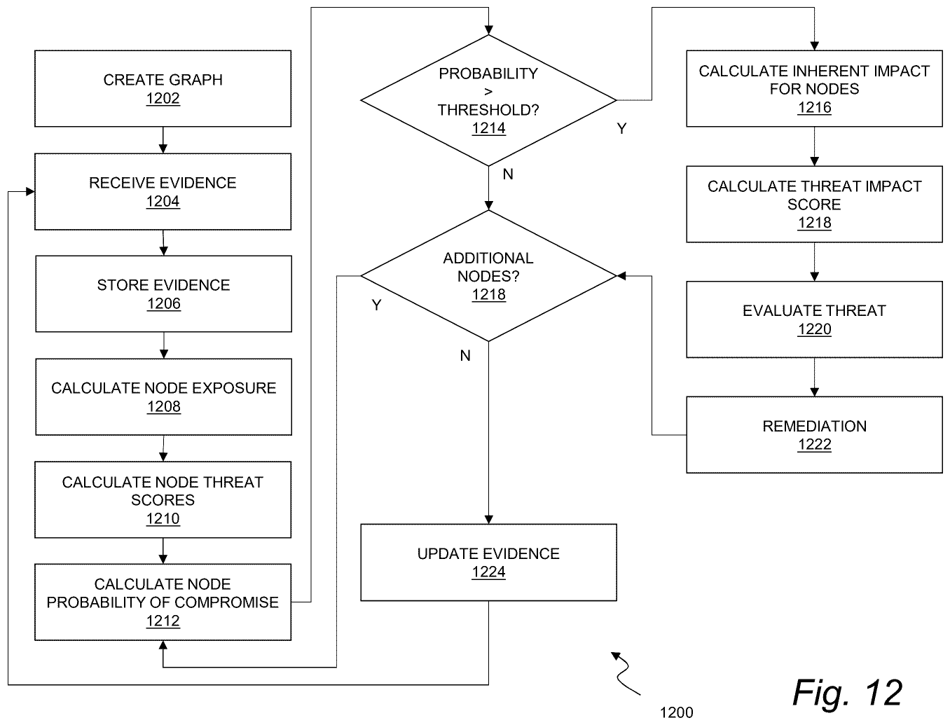

FIG. 12 is a flow chart of a method for compound threat detection. As described herein, a graph of nodes may be created representing entities in a cloud computing environment. Each one of the nodes of the graph can be characterized by inherent risks associated with known vulnerabilities and configuration details of the node, as well as a probability of exposure to other nodes based on access and control permissions for those other nodes connected to the node through the graph. In addition, the underlying value or sensitivity of data stored on the node may also be provided. With this data available as context, a probabilistic model for the relevance of threat evidence can then be derived from the graph and used to evaluate the overall riskiness or severity of accumulated evidence of threats to a node in the cloud computing environment.

As shown in step 1202, the method 1200 may include creating a graph of entities in a cloud computing environment for an enterprise network. As described herein, the graph may include a plurality of nodes, each one of the plurality of nodes representing an entity in a cloud computing environment such as a compromisable entity non-exclusively associated with a resource in the cloud computing environment. The graph may also include a plurality of edges, each one of the edges connecting two of the plurality of nodes and representing an access level between the two of the plurality of nodes.

In general, the structure of the graph may be generated using any suitable source(s) of information for network assets and connections therebetween, such as a management console, log database, or API for the cloud resource(s), independent auditing or tracking tools, or any other suitable combination of tools and resources for the cloud computing environment and/or from independent resources suitable for use with the cloud computing environment. Regardless of the source(s) of data used to create the graph, the structure may be stored in any suitable data structure accessible to a threat management facility or other service(s) responsible for evaluating threats as described herein.

As shown in step 1204, the method 1200 may include receiving evidence such as threat evidence for one or more of the plurality of nodes. In general, this may include evidence from any of the sources described herein including, e.g., node configuration data from the cloud computing environment, activity logs, traffic logs, workload agent data, data from a local security agent executing on one of the nodes, or any other source(s) of evidence that might relate to one of the nodes in the cloud computing environment and be used to evaluate potential threats as described herein.

As shown in step 1206, the method 1200 may include storing threat evidence for the plurality of nodes as one or more entries in an evidence table. The entries in the evidence table may have any data structure and may be stored in any form suitable for use in compound threat detection as described herein. In one aspect, each entry in the evidence table may an expiry time indicating an end of a useful life of the corresponding entry for evaluating threats to the enterprise network. It will be understood that, while the term evidence table is used, the evidence datastore does not need to be stored in table form and may have any suitable structure for storage and retrieval as contemplated herein.

As shown in step 1208, the method 1200 may include calculating a probability of exposure for each one of the plurality of nodes in the graph. For example, the probability of exposure may be based on an inherent exposure of the one of the plurality of nodes and an initial access probability for one or more other ones of the plurality of nodes connected to the one of the nodes by the edges of the graph. In this context, the inherent exposure (e.g., for a single node) may be calculated as a sum of conditional probabilities of compromise based on vulnerabilities for a corresponding one of the plurality of nodes. In general, the inherent exposure may be determined for each one of the plurality of nodes and an initial access probability may be determined for each one of the plurality of nodes. The probability of exposure may then be evaluated for each one of the plurality of nodes based on a probabilistic combination of the inherent exposure of the corresponding one of the plurality of nodes and the initial access probability of other ones of the plurality of nodes connected to the corresponding one of the plurality of nodes through the graph.

The exposure scoring may generally be as described herein. For example, in one aspect, the initial access probability may be calculated based on read permissibility and control permissibility for edges associated with a corresponding one of the plurality of nodes. The probability of exposure may be based in whole or in part on the inherent exposure of the one of the plurality of nodes and a product of the initial access probability and an exposure for each of one or more other ones of the plurality of nodes connected to the one of the nodes by the edges of the graph. The exposure for at least one of the one or more other ones of the plurality of nodes may depend on one or more other nodes connected by the graph to the at least one of the one or more other ones of the plurality of nodes.

As shown in step 1210, the method 1200 may include calculating a threat score for each node based on the value of threat evidence stored in the evidence table. In general, this may include calculating a threat score for the one of the plurality of nodes based on a value of the threat evidence for the one of the plurality of nodes and the one or more other ones of the plurality of nodes connected to the one of the nodes by the edges of the graph. More specifically, this may include calculating a threat score for a node as described herein.

As shown in step 1212, the method 1200 may include calculating a probability of compromise for one of the plurality of nodes. This may include calculating the probability of compromise based on the threat score for the one of the plurality of nodes and the probability of exposure for the one of the plurality of nodes.

As shown in step 1214, the method 1200 may include applying a threshold for further action to the probability of compromise for one of the nodes. In response to determining that the probability of compromise for the one of the plurality of nodes meets a predetermined threshold, the method 1200 may proceed to step 1216 for additional processing based on meeting the predetermined threshold. This may, for example, include a maximum or minimum score, or some other static or dynamic threshold for evaluating the likelihood that a current node is compromised or otherwise exposed or vulnerable in a manner posing a risk to the enterprise network. In response to determining that the probability of compromise for the one of the plurality of nodes does not meet the predetermined threshold, the method 1200 may proceed to step 1218 for further processing.

As shown in step 1216, the method may include calculating an inherent impact score for the one of the plurality of nodes and one or more neighboring nodes of the one of the plurality of nodes based on a value of stored data on each of the respective nodes. The one or more neighboring nodes may be selected, for example, based on an access threshold for at least one of read permissibility and control permissibility for an edge of the graph connecting the one of the plurality of nodes to each other one of the plurality of nodes.

As shown in step 1218, the method 1200 may include calculating an impact score for a potential threat as a maximum of the inherent impact score for the one of the plurality of nodes and the one or more neighboring nodes. In one aspect, the impact score may be calculated as described herein based on permission levels and the value of stored data for a selected one of the plurality of nodes.

As shown in step 1220, the method 1200 may include evaluating a threat to security as described herein based on the probability of compromise calculated in step 1212 and the impact score calculated in step 1218. In one aspect, a resulting score for threat severity may be displayed along with other threat scores in a use console for a security technician or the like. In one aspect, this usefully permits relative ranking of potential threats based on the nature of the threat, the degree of exposure to other nodes in the network via access, the sensitivity of data on a node, and so forth. By aggregating these factors into a probabilistic accounting for threat severity, useful side-by-side rankings can be generated for a user that help to direct attention toward the most severe risks requiring the most urgent attention.

As shown in step 1222, the method 1200 may include remediation. Where the threat to security is substantial, e.g., based on the probability of compromise and the impact score meeting threat severity thresholds, any one or more remedial actions may be initiated. This may include any of a variety of automated interventions such as quarantine, malware scanning, increased monitoring by a local security agent, updating security software, and so forth. This may also or instead include suitable alerts to customers, security administrators, and so forth. After any remediations are completed, the method 1200 may proceed to step 1218 where additional nodes can be considered.

As shown in step 1218, where additional nodes need to be scored, the method 1200 may return to 1212 for a calculation of the probability of compromise for the next node. If no additional nodes need to be scored, the method may proceed to step 1224 where evidence in the evidence table can be updated for a new round of scoring. In general, this may include reported events that are time stamped and stored in the evidence table, updates to node configuration, and so forth. The method 1200 may then return to step 1204 where the new evidence is received and scoring can for the resources of the cloud computing environment can be repeated.

According to the foregoing, there is also described herein a system for compound threat detection including one or more processors and one or more memories, wherein the one or more memories store a graph of entities in a cloud computing environment for an enterprise network, the graph including a plurality of nodes representing entities in the cloud computing environment and a plurality of edges, each one of the edges connecting two of the nodes and characterized by an access permissibility between the two of the nodes, an evidence table storing threat evidence for the plurality of nodes, and computer executable code that configures the one or more processors to evaluate a riskiness of one of the nodes based on an inherent threat score of the one of the nodes, and a probability weighted sum of contributions of inherent threat scores for other nodes connected to the one of the nodes through the graph. The probability weighted sum may apply weights to each edge of the graph connecting the one of the nodes to one of the other nodes according to a corresponding access permissibility associated with the edge. The one or more processors may, for example, be associated with a threat management facility or other resource providing security to the cloud computing environment.

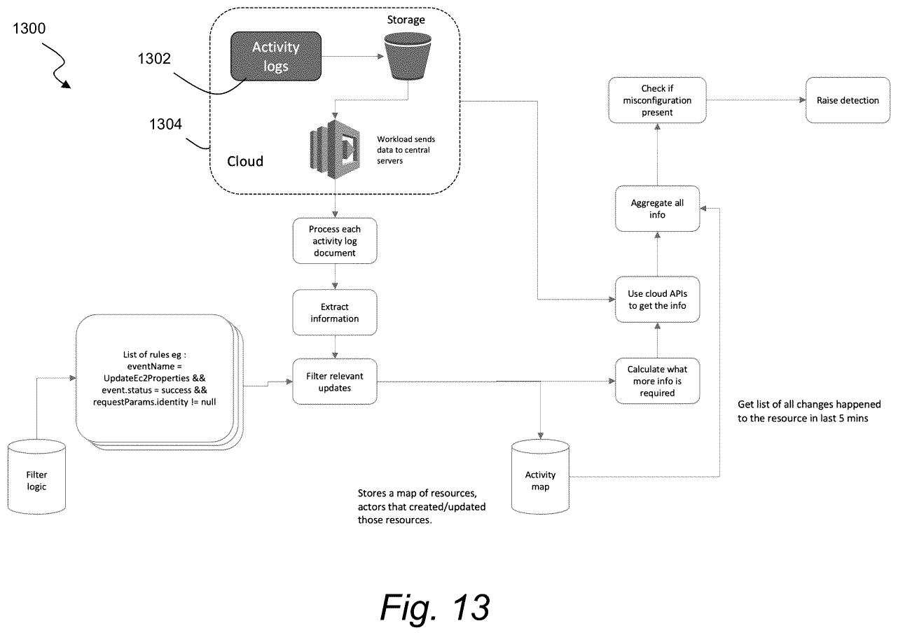

FIG. 13 illustrates a method for rapid exposure detections. In the method 1300, a log 1302 of resource modifications in a cloud computing environment 1304 may be incrementally transmitted to a threat management facility. The threat management facility can analyze the log 1302, along with related identity information, to determine when additional information might be useful to detect a malicious misconfiguration of cloud resources. The threat management facility can then access additional information through an application programming interface, and the additional information can be used to perform a detection, initiate remediation, and so forth. This approach advantageously permits fast detection of potential threats based on the continuous log reporting, while deferring high-latency API access to the cloud platform (and/or other computationally expensive operations) until appropriate for confirming or investigating potential detections that are raised based on the log.

Cyber-attacks often exhibit rapid evolution, necessitating swift detection. The speed of detection remains a key metric monitored across various tools in the security and cloud detection industries. Existing tools may review cloud misconfigurations that lead to exposure from the perspective of compliance, where companies seek to maintain a healthy security posture and manage risk. Identifying and mitigating non-compliant resources is a continuous process for an enterprise. On the other hand, specific non-compliant resource configurations can be a sign of immediate compromise where time to action matters, such as when a resource misconfiguration results in public exposure of critical resources or sensitive data. For example, a misconfigured S3 bucket containing sensitive data may render the sensitive data public by mistake. Most security tools use agentless methods to detect cloud misconfigurations. This involves using cloud APIs and SDKs to fetch resource configurations and process them at a central place. This data sync needs to happen at regular intervals which may vary from a few hours to once daily. While this permits central management of threat exposures, this can also result in significant latency between compromise and detection.

Described herein are techniques that use log data from a cloud computing environment, such as activity logs or audit logs data published by a cloud providers. Each cloud provider records every action taken by a user/system in the cloud that modifies a cloud resource, and this data is stored in a log, typically along with basic information about who made the change, the type of resource, the type of action, and a unique identifier for the cloud resource. There may be other details available depending on the cloud provider, and logging functions may be configurable to provide more or less data. A cloud computing platform may continuously export these logs out of the customer cloud environment to a threat management facility, e.g., by streaming data or providing incremental updates on some regular schedule. The threat management facility may filter this log data to focus on events that may have caused a misconfiguration. When a misconfiguration or potential misconfiguration is detected, the threat management facility may then fetch additional information from the cloud computing platform using APIs in order to support a detection. In this context, the latest information may be required to ensure correctness of the detection and to make sure that an alert is not raised based on stale data. Information about who made the change may also be extracted from activity logs and associated with the detection.

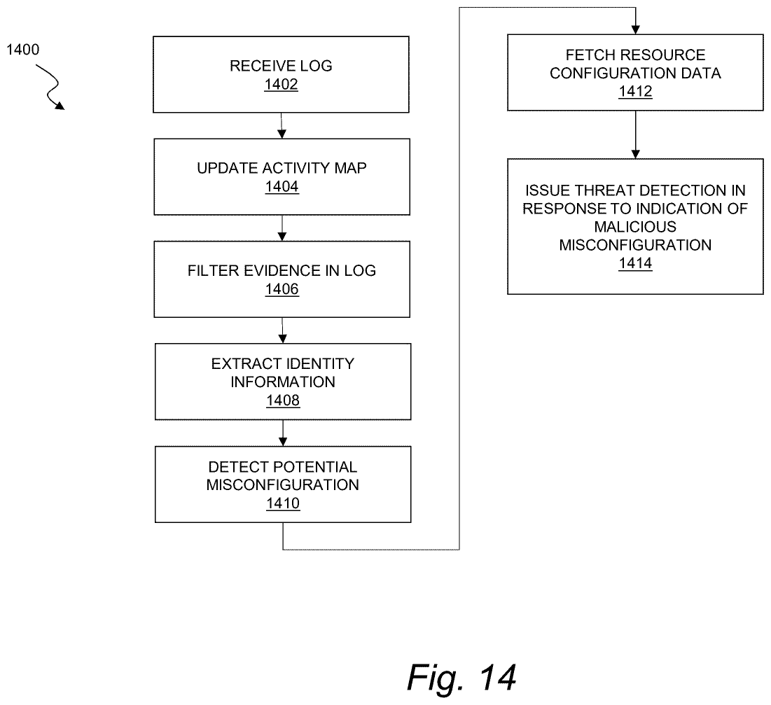

FIG. 14 shows a method for rapid exposure detections in a cloud computing environment. In one aspect described herein, a log of resource modifications in a cloud computing environment is incrementally transmitted to a threat management facility. The threat management facility can analyze the log, along with related identity information, to determine when additional information might be useful to detect a malicious misconfiguration of cloud resources. The threat management facility can then access additional information through an application programming interface, and the additional information can be used to perform a detection, initiate remediation, and so forth. This approach advantageously permits fast detection of potential threats based on the continuous log reporting, while deferring high-latency API access to the cloud platform (and/or other computationally expensive operations) until appropriate for confirming detections that are raised based on the log.

As shown in step 1402, the method 1400 may include receiving a log of a plurality of modifications to cloud resources. The log may, in general, be published by the cloud computing environment, and may be received at a threat management facility such as any of the threat management facilities described herein. In general, the cloud computing environment may host resources for an enterprise network managed by the threat management facility.

The log may be incrementally transmitted to the threat management facility on any suitable intermittent schedule. This may, for example, include a regular schedule, e.g., on recurring intervals, or this may include a dynamic schedule such as an interval that changes according to the volume of log activity, the nature of log activity, or a schedule that changes based on any other criteria useful for controlling the cadence of log streaming, as well as any combination of the foregoing. For example, the cloud computing environment may generate an incremental update to the log at least once per minute, or at any other suitable time interval. The cloud computing environment may stream the log to the threat management facility as a plurality of incremental updates in any suitable volume, data rate, aggregation, and so forth.

As shown in step 1404, the method 1400 may include updating an activity map. Where potentially malicious activity (or any activity) occurs in a cloud computing environment, it may be difficult to directly discern the nature and extent of the activities by a single actor. In order to facilitate tracking of entity-specific actions, identity information may be located in activities in the streamed data log and used to build an activity map. The activity map may, for example, include resources, entities, and resource modifications for one or more detected resource modifications detected at the threat management facility based on a stream of log data from the cloud computing environment. For example, for a detected resource modification, the activity map may store at least one of an email address, a user name, or a unique cloud identifier for a corresponding entity associated with the resource modification.

As shown in step 1406, the method 1400 may include filtering the log in any suitable manner. For example, this may include filtering the log to identify one of the plurality of modifications in the log data associated with a potential misconfiguration of cloud resource. This may, for example, include a configuration of one of the cloud resources that is inconsistent with an explicit policy for the enterprise resource, or a configuration of one of the cloud resources that presents a known vulnerability. More generally, any configuration that is known to be potentially insecure, unstable, associated with malicious activity, or inconsistent with an explicit security policy, may be used to trigger further action. Where a particular configuration modification is immediately identified as malicious, additional processing may be omitted, and the threat management facility may move immediately to intervention and remediation using any suitable tools and techniques.

As shown in step 1408, the method 1400 may include extracting identity information for an entity that initiated one of the plurality of modifications. This may, for example, include looking up one or more identities associated with the potential misconfiguration in the activity map created from the log data, or otherwise filtering or processing data from the cloud computing environment to identify entities associated with detected resource configurations. This may also or instead include identifying other entities associated with the entity so that additional activity data from the log can be associated with the potential misconfiguration and used to identify potentially malicious activity.

As shown in step 1410, the method 1400 may include detecting a potential misconfiguration based on data in the received log from the cloud computing environment. This may, for example, include applying any set of rules or other detection heuristics or mechanisms to identify potential misconfigurations such as any change in resource configuration that is inconsistent with an explicit policy for the enterprise resource, that suggests malicious activity, or that presents a possible vulnerability or otherwise indicates a potential compromise.

As shown in step 1412, the method 1400 may include, in response to detecting the potential misconfiguration, fetching resource configuration data related to the potential misconfiguration from the cloud computing environment to the threat management facility. This may, for example, including fetching the resource configuration data using an application programming interface for the cloud computing environment. In one aspect, this may include fetching resource configuration data that is of a type not provided in the stream of log data, either because it is not available, or because it has been filtered to reduce network traffic. This may also or instead include fetching resource configuration data before a next incrementally transmitted log update is published by the cloud computing environment. In either case, the fetch may provide an update to the resource configuration data for use in a threat analysis of the resource configuration by the threat management facility.

The resource configuration data fetched via the application programming interface may include any configuration data useful for analyzing threats and may include specifically requested data or all configuration data available since the last log update, or some combination of these. In one aspect, the resource configuration data may include one or more security settings for the cloud computing environment. The resource configuration data may also or instead include one or more properties of one of the cloud resources.

As shown in step 1414, the method 1400 may include issuing a threat detection when the identity information and the resource configuration data indicate a malicious misconfiguration of the cloud resources in the cloud computing environment. For example, this may include displaying a threat detection in a console for the threat management facility, transmitting a notification by electronic mail or other messaging medium to a security administrator or other personal, or otherwise providing a notification to one or more individuals of the detected threat. In one aspect, the resource configuration data may include the update received in response to the data fetch using the application programming interface for the cloud computing environment.

According to the foregoing, in one aspect there is disclosed herein a system for rapid exposure detection in a cloud computing environment, the system including a cloud computing environment hosting resources for an enterprise network and a threat management facility providing services to the enterprise network. The cloud computing environment may be configured to publish a log of a plurality of modifications to cloud resources on a predetermined schedule. The threat management facility may be configured by computer executable code to perform the steps of: receiving the log from the cloud computing environment, filtering the log to identify one of the plurality of modifications associated with a potential misconfiguration of the cloud resources, extracting identity information for an entity that initiated the one of the plurality of modifications, and in response to the potential misconfiguration, fetching resource configuration data related to the potential misconfiguration from the cloud computing environment using an application programming interface for the cloud computing environment.

The threat management facility may be further configured to perform the step of issuing a threat detection when the identity information and the resource configuration data indicate a malicious misconfiguration of the cloud resources in the cloud computing environment. Extracting identity information may, for example, include looking up one or more identities associated with the potential misconfiguration in an activity map stored by the threat management facility, such as any of the activity maps described herein.

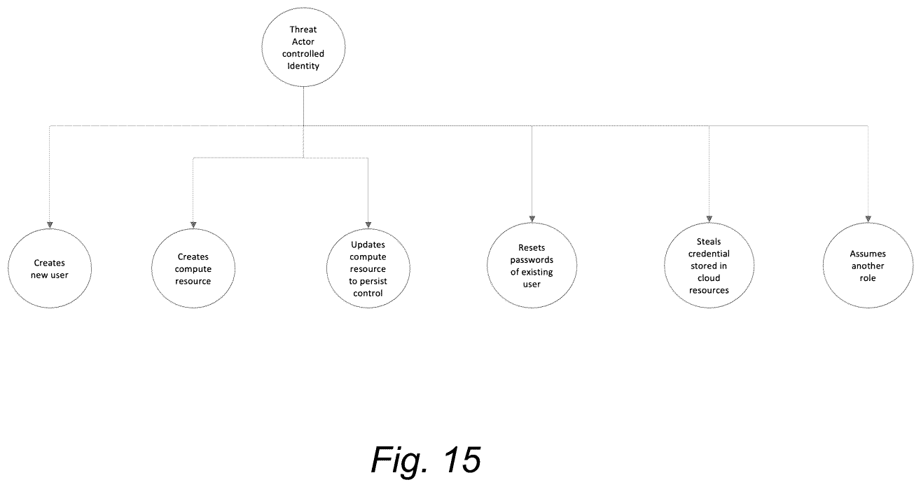

FIG. 15 illustrates mechanisms by which a threat actor can gain access to different identities or credentials in an enterprise. In one aspect, a threat actor may gain access to cloud computing resources and create a new user and use the user credentials for further activity. For example, the threat actor can then update the password for an existing user and gain control of a user account. In cloud computing environments, resources can also be assigned role-based access to other resources or permissions to perform operations. A threat actor may create a resource and assign permissions to it and then configure a mechanism to control and carry out their attack via that resource. In another aspect, threat actors may also or instead modify existing resources such as old or unused resources with less visibility, and setup control for carrying out an attack with these pre-existing resources. While threat actors can create their own identities and credentials for malicious purposes, they may also discover un-encrypted credentials hardcoded inside workloads, or usable credentials stored in resource properties or in secure vaults provided by cloud providers. Additionally, some cloud providers provide mechanisms for an identity to assume other identities, and this may be used to obfuscate the identity of an attacker during various steps in a multi-stage attack.

In order to address these types of threats, a variety of techniques may be used to track threat actors across multiple identities in cloud computing environments, and to create a persistent database of identity mappings that can be used to improve threat detection in the cloud computing environment by facilitating the identification of attacks that are coordinated among two or more different identities under common control.

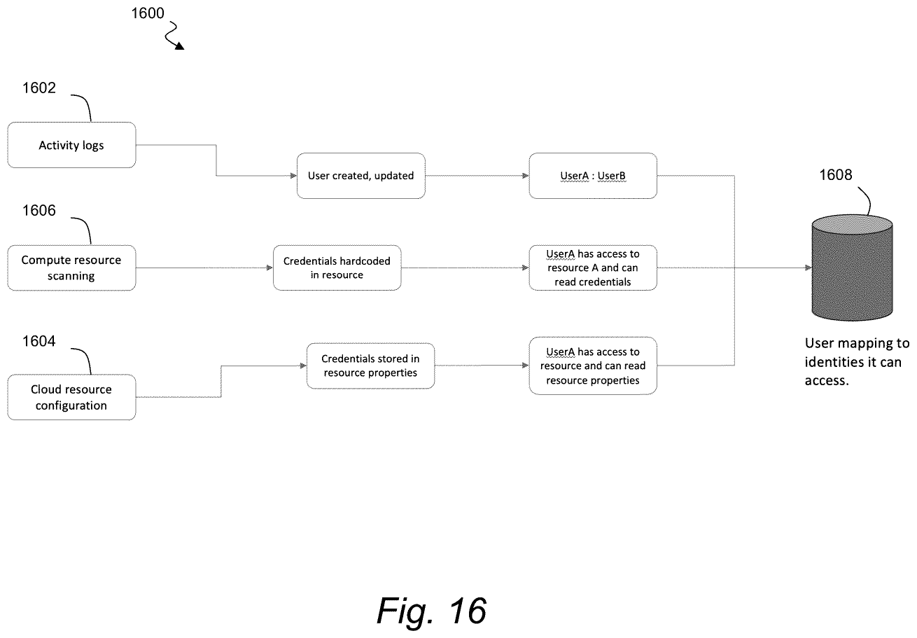

FIG. 16 illustrates a process for generating an identity mapping database. Threat actors employ strategies where they switch between various identities in order to evade defenses, escalate privileges and persist in customer cloud environments. Security tools with activity based threat detections capabilities often fail to detect these threat actors. The process 1600 described herein uses various data sources from the cloud computing environment to detect threat actors that switch identities during an attack.

A first mechanism 1602 for resolving identities uses activity logs from a cloud computing environment to identify relationships between various identities. Information regarding an identity that performed an action, along with a new identity created by or affected by the action, can both be extracted from activity logs data and stored in an identity mapping database by a threat management facility or the like. For each action, the identity mapping database 1608 may store (i) a time of the action, (ii) a type of the action, (iii) a first identity of an actor that initiated, caused, or performed the action, and (iv) a second identity of an actor that is affected by the action. Using this mechanism the threat management facility can establish relationships for attack scenarios described above. In one aspect, the identity mapping database 1608 may include or may be included by the activity mapping database described herein, which more generally associates activities in the cloud computing environment with specific identities in the cloud computing environment.

A second mechanism 1604 for resolving identities uses cloud APIs to fetch resource properties from the cloud computing environment and scans the resource properties for credentials. These credentials can then be mapped to existing identities in the cloud environment. Any read event of properties of these resources is then recorded as a credential read event in the identity mapping database 1608 of the threat management facility for managing attack scenarios described above. Each entry in the identity mapping database 1608 may include (i) a time of access, (ii) a type of action, (iii) a first identity of an actor that reads the credential(s), and (iv) a second identity of an actor associated with the credential(s).

A third mechanism 1606 may use a scanner such as a Linux program, windows executable, background process, microservice, or the like continuously running on a customer workload (such as a virtual machine, serverless machine, container, compute instance, or other cloud-based endpoint) that scans all files on the customer workload for hard-coded credentials. The mechanism may use resource configurations, other resource configuration data, or other data to determine if any of the hard-coded credentials belong to an identity. These credentials can then be mapped to existing identities in the cloud computing environment. The mechanism may iterate through all identities, roles, and/or permissions to determine which identities have access to the workload where the credentials were found. These relationships and associations may then be recorded. Threat actors may use various mechanisms provided by cloud providers to access these credentials that include but are not limited to running remote shell, running commands remotely, and so forth. Depending on the access method, the cloud identity scanning for the credentials cannot be reliably associated with the cloud identity associated with the workload. Thus, the third mechanism 1606 may assume that an actor identity is the identity associated with the corresponding workload, which has access to any credentials stored on the workloads where the scan is being performed. The relationship may be stored in the identity mapping database 1608 of the threat management facility in a record that specifies (i) a time the credential is discovered by the scanner, (ii) a type of action, (iii) a first identity of an actor associated with the workload where the scanner is executing, and (iv) a second identity of an actor associated with the credential(s).

In general, these various entity-to-entity mappings are stored in the identity mapping database 1608 and used to identify cooperative actions by a number of different cloud identities when trying to detect malicious activity in the cloud computing environment.

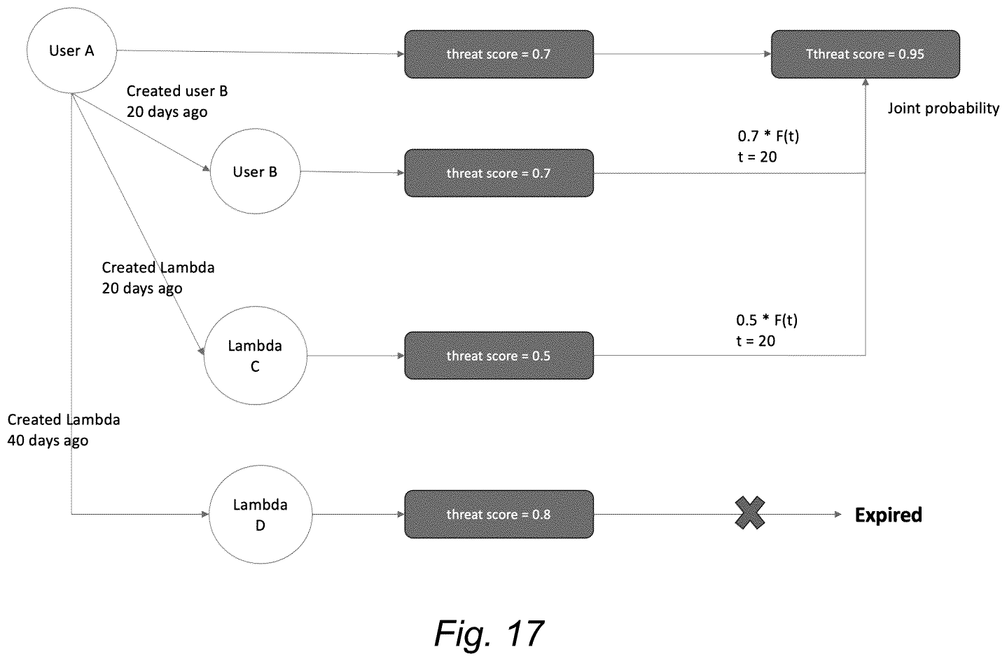

FIG. 17 illustrates a technique for using an identity mapping database to detect threats in a cloud computing environment. In general, the identity mapping database may be any of the identity mapping databases described herein, and the identity mappings stored in the identity mapping database can be used to add identity tracking capability by any threat detection tool used by the threat management facility. For example, the identity mapping database may be used to calculate a threat or risk score for each identity being compromised, and then a threshold may be applied to create a detection.

In the illustrated example, a threat score may be calculated for an identity by combining a threat score for the identity with one or more other threat scores of one or more other identities associated with the identity in the identity mapping database. The score may account for time. For example, the score for the contribution of each identity association, each activity by an identity, or some combination of these may factored by time passed since the association was created. The passage of time may be useful in this context because real world attacks may be time bounded based on type, and the time range for various threats and threat-related activities may range from a few seconds or minutes to several months. The time factor illustrated in the figure may be an exponential decay such as:

$$F ( t ) = {k}_{1} {e}^{\frac{- t}{{k}_{2}}}$$

Where k₁ is a magnitude scaling constant for the factor, t is the number of days since an association or other related event, and k₂ is a time scaling constant for the rate of decay. More generally, any form of equation that provides a time-based decay in the contribution of an identity association may be used, depending on the type of activities, the nature of the association, and any other relevant criteria. The decay in contribution of an identity association may be exponential in order to capture the fact that the probability of an identity being created or updated by a threat actor and then used to carry out an attack is higher on a short timescale than a long time scale. However, other decay or expiration models may also or instead be used. To save a computation, risk factors with scores smaller than a threshold, such as 0.05, may be set to zero or removed from a database or scored activities, and the mapping for any associated identity may be removed from the persistent database. This approach can also mitigate noise by focusing on temporally relevant mappings.

As illustrated in the figure, a threat score may be calculated as a joint probability of the threat score for a number of related actors—in this case, User A, User B, Lambda C, and Lambda D. A detection may usefully be raised for User A, even where the threat score of User A in isolation is below a threshold for detection. For example, contributions from related identities User B and Lambda C can push the score for an identity over a reporting threshold. By precalculating causal relationships between identities, the disclosed technique can improve detection of threat actors that use identity switching as part of an attack. The precalculated relationships may also help threat hunters such as security analysts to visualize and understand an attack path.

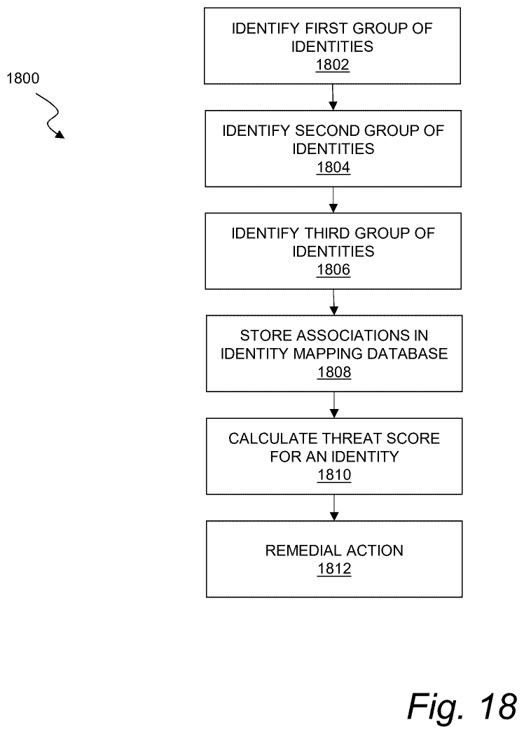

FIG. 18 is a flow chart of a method for tracking threat actors across cloud identities. In general, a variety of techniques may be combined to locate and characterize relationships among user identities in a cloud computing environment, and to create a persistent database of identity mappings. The resulting identity mapping database can enable improved threat detection in the cloud computing environment, particularly in cases where an attack might otherwise be obscured as a number of low-severity detections associated with different entities. For example, the identity mapping database can facilitate threat scoring for a group of related entities and the detection of attacks that are coordinated among two or more such identities. The identity mapping database may also or instead be used to identify an attacker that hides an attack by switching identities during the attack. The following method 1800 may be deployed, e.g., using a threat management facility that provides security services for a customer hosting resources on the cloud computing environment.

As shown in step 1802, the method 1800 may begin with identifying a first group of related identities in a plurality of identities controlled by a single entity. This may include identifying the first group of related identities using audit logs. For example, this may include using audit logs that provide information regarding one of the identities of the plurality of identities that performed an action to create or affect another one of the identities of the plurality of identities in the cloud computing platform. Thus, or example, where a user creates another user identity, resource, or the like, this may be identified in the audit logs and used to create a corresponding association.

As shown in step 1804, the method may include identifying a second group of related identities in the plurality of identities controlled by the single entity. This may include identifying the second group using resource properties fetched through an application programming interface for the cloud computing environment. For example, the threat management facility may use this second technique by using an application programming interface for the cloud computing environment to fetch resource properties and scan the resource properties for user credentials.

As shown in step 1806, the method 1800 may include identifying a third group of related identities in the plurality of identities controlled by the single entity. This may include using a third technique to locate hard-coded credentials on cloud instances in the cloud computing environment. For example, this may include scanning files with a workload running on cloud instances in the cloud computing environment to locate hard-coded credentials. Hard-coded credentials may be located, e.g., based on any suitable heuristics according to format, location, or any other suitable techniques. Each pair of related identities detected based on hard-coded credentials identified by the workload may, for example, be stored as a record including a time of discovery of the hard-coded credentials, a type of access by the workload, an actor identity having access to the workload, and an affected identity associated with the hard-coded credentials. In general, the workload may be any workload suitable to a cloud computing environment. For example, the workload may include an executable in a Windows environment, a container in a Linux environment, a virtual machine, or a serverless machine.

As shown in step 1808, the method 1800 may include generating an identity mapping database for the cloud computing environment by storing the first group of related identities, the second group of related identities, and the third group of related identities in the identity mapping database. The identity mapping database may, for example, identifying each of the plurality of identities controlled by the single entity. Each record in the identity mapping database may include a time, a type, an actor identity, and an affected identity.

Other data may also or instead be stored. For example, the identity mapping database, or an accompanying activity mapping database, may store an action between a pair of related identities detected based on audit logs. This may be stored, e.g., as a record of an identity action event including a time of the action, a type of the action, a first identity causing the action, and a second identity affected by the action. More generally, a record in the identity mapping database may include a time, a type, an actor identity, and an affected identity.

The specific data in a record of the identity mapping database may depend on the manner in which an identity relationship was identified. In general, this may reflect the nature of the available data, the nature of the relationship between the two associated identities, and so forth. For example, an action between a pair of the identities detected based on the audit logs may be stored in the identity mapping database as a record of an identity action event including a time of the action, a type of the action, a first one of the pair of identities causing the action, and a second one of the pair of identities affected by the action. A read event detected between a pair of identities based on user credentials in the resource properties may be stored in the identity mapping database as a record of a credential read event including a time of the read event, a type of the read event, and a first one of the pair of identities initiating the read event, a second one of the pair of identities affected by the read event. A pair of the identities detected based on the hard-coded credentials may be stored in the identity mapping database as a record including a time of discovery of the hard-coded credentials, a type of access by a workload detecting the hard-coded credentials, an actor identity having access to the workload, and an affected identity associated with the hard-coded credentials. More generally, each record may include any data or inferences available from the detected relationship and useful for detecting multi-identity attacks as contemplated herein.

As shown in step 1810, the method 1800 may include calculating a threat score for a first one of the plurality of identities controlled by the single entity based on threat data for each other one of the plurality of identities associated with the single entity in the identity mapping database. Calculating the threat score may, for example, include calculating the threat score as a joint probability of a first entity threat score for the one of the plurality of identities and one or more other entity threat scores for each other one of the plurality of identities related to the one of the plurality of identities in the identity mapping database.

In one aspect, calculating a threat score may include storing an evidence table of threat data for use in evaluating threats. Thus, for example, the threat data may include an evidence table or the like including one or more records, with each of the one or more records including an identifier for one of the plurality of identities associated with a corresponding item of threat data in the record. The item of threat data may, for example, include a threat score, severity evaluation, description, identifier, and/or other information for determining the type and/or the severity of the related activity. In one aspect, the evidence table may also include an expiration time for one or more of the records after which the record is excluded from threat scoring for a corresponding one of the plurality of identities.

As shown in step 1812, the method 1800 may include initiating a remedial action. This may be any remedial action described herein, and/or any remedial action suitable for the calculated threat score. For example, this may include automatically initiating a remedial action or providing a notification to a technician or other security personnel in a threat management console of the threat management facility or transmitting a notification of the detected threat in an electronic mail, text message, or other message or the like.

In another aspect, a system described herein includes a memory storing an identity mapping database for a cloud computing environment that includes a plurality of identities and a threat detection module executing on a processor of a threat management facility. In the memory, the identity mapping database may identify related identities, from among the plurality of identities, controlled by a single entity in the cloud computing environment, one or more related identities in the identity mapping database may be identified using audit logs for the cloud computing environment that provide information regarding an identity in the cloud computing environment that performed an action to create or affect another identity in the cloud computing environment, one or more related identities in the identity mapping database may be identified using an application programming interface for the cloud computing environment to fetch resource properties and scan the resource properties for user credentials, and one or more related identities in the identity mapping database may be identified by scanning files for hard-coded credentials with a workload running on cloud instances in the cloud computing environment.

The threat detection module may be configured by computer executable code stored in the memory or another memory of the threat management facility to calculate a threat score for one of the plurality of identities based on threat data for one or more of the plurality of identities related to the one of the plurality of identities in the identity mapping database. In one aspect, the threat score may be calculated as a joint probability of a first entity threat score for the one of the plurality of identities and one or more other entity threat scores for each of the one or more of the plurality of identities related to the one of the plurality of identities in the identity mapping database. In another aspect, each record in the identity mapping database may include a time, a type, an actor identity, and an affected identity.

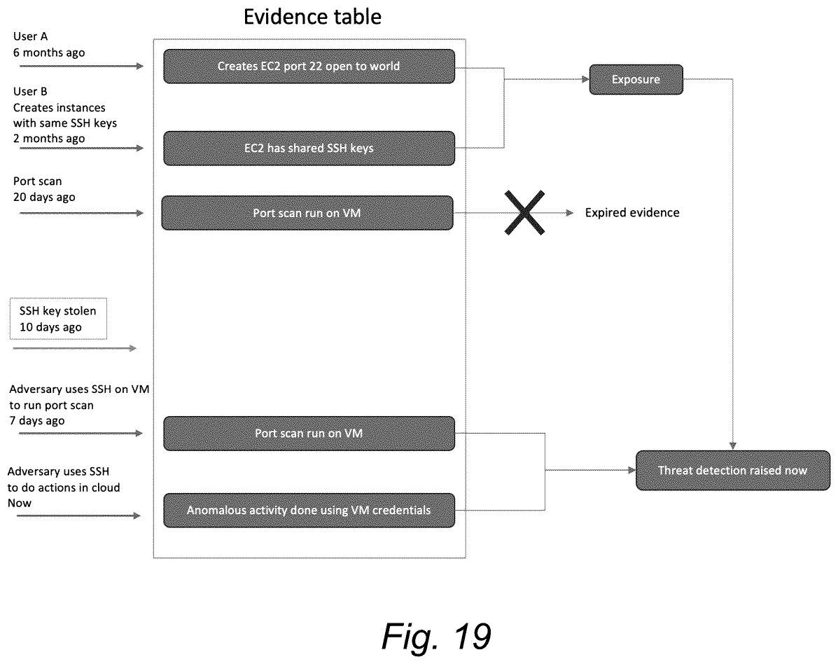

FIG. 19 illustrates a technique for threat detection using an evidence table with expiration times. In general, an evidence table for threat data in a cloud computing environment permits independent tracking of several parameters related to the potential threat posed by a new instance of threat data. The evidence table may, for example, record a time of the evidence, a first measure of threat severity, a second measure of a duration over which the evidence remains relevant, and a third measure of a dependency on other types of threat data. This approach advantageously improves threat detection by facilitating storage and analysis of threat information based on the significance, temporal relevance, and interdependency with other threat information, without requiring persistent tracking of all available threat information for a cloud computing environment.

Customer cloud environments can be compromised by adversaries using stolen credentials, vulnerabilities, overly exposed resources, and malware. Once a cloud computing environment is compromised, adversaries may gain access to confidential data, applications within the environment and in some cases full access to customer cloud environments. Real world attacks to cloud computing environments may span from a few minutes to months. In some scenarios, after attackers gain access to cloud systems, they use defense evasion methods to silently move laterally through environments. Attackers can keep the level of their activity low and cover their tracks to evade threat detection tools, making detection difficult. A threat detection tool that relies on user activity to create detections may use shorter time frames of activity, or process one event at a time. Threat hunters then have to manually track down related activities, drilling into history as they find new signals. This poses significant overhead for security analysts and may not be practical in environments with large volumes of forensic data.

To address this challenge, the techniques described herein combine potentially relevant, low confidence threat signals across long time frames such as weeks in order to support a compound detection with high confidence based on all relevant evidence. As used herein, evidence includes low confidence threat signals that individually may not trigger a detection. The system continuously collects evidence. The relevance of evidence may depend in part on how long, e.g., a misconfiguration associated with an exposure has been present in the system, or more generally, the time at which evidence, and combinations of evidence, have occurred. For example, evidence of an exposure may be relevant while creating a threat detection, e.g., if a particular misconfiguration is present, or was present during the time frame activity related to other data indicative of an attack. The system may also collect threat evidence based on activity happening on workloads, and any related cloud actions or the like. In general, the importance of evidence may depend on the time that it occurred relative to other evidence, or the time since it occurred. In order to address this issue, time data and/or expiration data may be associated with threat evidence using predetermine rules and dependencies. For example, a login anomaly evidence might only be considered (as relevant to a detection) after multi-factor authentication has been disabled for a user. Then threat evidence may be aged or expired as appropriate, e.g., if it has occurred before or not around the time of certain exposure or other threat evidence.

In one aspect, each recorded item of threat evidence may also be assigned an expiry time depending on the frequency of the action and its relevance or use in known attacks. For example, a port scan on workloads that happens frequently may be assigned an expiration time of a shorter period (e.g., seven days), whereas an anomalous login event may be assigned an expiration time of thirty days. The system may continuously process evidence that has not expired to check if a detection should be raised. A detection may be based on combinatorial logic applied to a set of core evidence. Each time the system receives an item of core evidence; it may combine all non-expired evidence to evaluate for threats.

In the example of FIG. 19, threat detection is performed using an evidence table with expiration times, more specifically in the context of an Amazon Elastic Compute Cloud (“EC2”) compromise. In a hypothetical situation an attacker gains access to SSH keys of an EC2 instance by obtaining access via port 22 of the EC2 instance. A threat detection algorithm executing on a threat management facility and using the evidence table, may continuously collect evidence related to the EC2 instance. When evidence of a low severity anomaly activity is detected related to the instance, a threat detection algorithm executing on the threat management facility may check for evidence that has not expired. A port scan that happened twenty days before the anomaly may not be considered, while a port scan seven days before the anomaly may be used as evidence to raise a detection. While this example is provided in the context of Amazon Elastic Compute Cloud, it will be understood that the same principles may be applied to any web service providing scalable compute capacity in the cloud, or more generally, any cloud computing environment that might be used by an enterprise to host an enterprise network and/or enterprise resources.

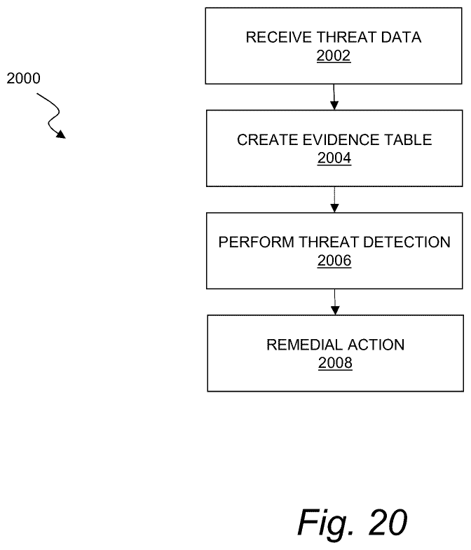

FIG. 20 is a flow chart of a method for detecting persistent attacks in cloud computing environments using an evidence table with expiration dates. In general, an evidence table for threat data in a cloud computing environment permits independent tracking of several parameters related to the potential threat posed by a new instance of threat data. The evidence table may, for example, combine a first measure of threat severity, a second measure of the duration over which an instance of threat data remains relevant, and a third measure of dependency on other types of threat data. This approach advantageously improves threat detection by facilitating storage and analysis of threat information based on the significance, temporal relevance, and interdependency of threat information without requiring persistent tracking of all available threat information for a cloud computing environment.

As shown in step 2002, the method 2000 may include receiving threat data from a cloud computing environment. For example, this may include receiving threat data from a cloud computing environment that hosts resources for an enterprise network at a threat management facility that provides security services for the enterprises network.

As shown in step 2004, the method 2000 may include creating an evidence table. For example, this may include storing the threat data one or more records in an evidence table, e.g., at the threat management facility. Each record in the evidence table may include a type of the corresponding threat data, a severity score for the corresponding threat data, and an expiry time for the corresponding threat data. One or more of the records in the evidence table may also include a dependency on one or more types of threats identified in the evidence table.

The type may, for example, include a description of a threat type for the corresponding threat data in the record of the evidence table. This may include a name of the threat, an identifier for the threat, a type of attack or malicious actor associated with the threat, one or more behavioral aspects of the threat, and so forth. The severity score may include any suitable quantitative assessment of a severity level, a malware confidence level, or any other quantitative measure of risk, severity, threat, or the like associated with the threat data. The expiry time may include an amount of time for which the corresponding threat data remains relevant to threat detection in the cloud computing environment, or an amount of time for which the corresponding threat data will be used when performing the threat detection for the cloud computing environment.

As shown in step 2006, the method 2000 may include performing a threat detection for the cloud computing environment based on an aggregation of non-expired records in the evidence table. For example, this may include calculating a score as a sum, joint, probability, or other combination of individual severity scores in the evidence table, with expired entries removed and/or de-weighted based on increasing age. The threat detection may also or instead evaluate at least one of the records based on one or more other records including the dependency of or on the same type. For example, the type in the evidence table for various records may include a misconfiguration of the cloud computing environment, a workload activity on a compute instance in the cloud computing activity, a cloud action by a compute instance in the cloud computing activity, or a login anomaly. When evaluating a record with a type of “login anomaly,” the evaluation may be based on one or more other records having the type of “login anomaly.”

As shown in step 2008, the method 2000 may include initiating remedial action. This may include any suitable remediation based on the score calculated during threat detection in step 2006 above. For example, this may include initiating remedial action when the score meets a predetermined threshold, and the remedial action may include any remedial action described herein, and/or any remedial action suitable for the calculated threat score. For example, this may include automatically initiating a remedial action or providing a notification to a technician or other security personnel in a threat management console of the threat management facility or transmitting a notification of the detected threat in an electronic mail, text message, or other message or the like. The remedial action may include initiating a scan of a compute instance, updating security software, updating applications, updating an operating system, quarantining a resource, requesting additional data from a resource, and so forth.

According to the foregoing, a system described herein includes a cloud computing environment hosting resources for an enterprise network and a threat management facility. The threat management facility may provide security services for the enterprise network, and may be configured by computer executable code embodied in a non-transitory computer readable medium to perform the steps of: storing the threat data as one or more records in an evidence table wherein: each record in the evidence table includes a type of the corresponding threat data, each record in the evidence table includes a severity score for the corresponding threat data, and each record in the evidence table includes an expiry time for the corresponding threat data; and performing a threat detection for the cloud computing environment based on an aggregation of non-expired records in the evidence table.

Any of the foregoing techniques, including threat detection based on an identity mapping database, an activity mapping database, an evidence table, or any of the other data sets created as described herein, and/or threat detection using any of the scoring methods described herein, may be used alone or in any suitable combination to improve the accuracy, timeliness, and computational efficiency of cloud threat detection.

The methods, systems, devices, and computer program products described herein may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described herein may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described herein may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described herein may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described herein are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Absent an explicit indication to the contrary, the disclosed steps may be modified, supplemented, omitted, and/or re-ordered without departing from the scope of this disclosure. Thus, while particular embodiments have been shown and described, it will be apparent to those skilled in the art that various changes and modifications in form and details may be made therein without departing from the spirit and scope of this disclosure and are intended to form a part of the invention.

What is claimed is:

1. A computer program product comprising computer executable code stored in a non-transitory computer readable medium that, when executing on one or more computing devices, causes the one or more computing devices to perform the steps of:
identifying a first group of related identities in a plurality of identities for a cloud computing environment that are controlled by a single entity, wherein identifying the first group includes using audit logs that provide information regarding one of the identities of the plurality of identities that performed an action to create or affect another one of the identities of the plurality of identities in the cloud computing platform;
identifying a second group of related identities in the plurality of identities controlled by the single entity using an application programming interface for the cloud computing environment to fetch resource properties and scan the resource properties for user credentials;
identifying a third group of related identities in the plurality of identities controlled by the single entity by scanning files with a workload running on cloud instances in the cloud computing environment to locate hard-coded credentials;
storing the first group of related identities, the second group of related identities, and the third group of related identities in an identity mapping database for the cloud computing environment, the identity mapping database identifying each of the plurality of identities controlled by the single entity; and
calculating a threat score for a first one of the plurality of identities controlled by the single entity based on threat data for each other one of the plurality of identities associated with the single entity in the identity mapping database.

2. The computer program product of claim 1, wherein calculating the threat score includes calculating the threat score as a joint probability of a first entity threat score for the one of the plurality of identities and one or more other entity threat scores for each other one of the plurality of identities related to the one of the plurality of identities in the identity mapping database.

3. The computer program product of claim 1, wherein each record in the identity mapping database includes a time, a type, an actor identity, and an affected identity.

4. The computer program product of claim 1, wherein an action between a pair of related identities detected based on audit logs is stored in the identity mapping database as a record of an identity action event including a time of the action, a type of the action, a first identity causing the action, and a second identity affected by the action.

5. The computer program product of claim 1, wherein each read event between a pair of related identities detected based on user credentials in the resource properties is stored in the identity mapping database as a record of a credential read event including a time of the read event, a type of the read event, a first identity initiating the read event, a second identity affected by the read event.

6. The computer program product of claim 1, wherein each pair of related identities detected based on hard-coded credentials identified by the workload is stored as a record including a time of discovery of the hard-coded credentials, a type of access by the workload, an actor identity having access to the workload, and an affected identity associated with the hard-coded credentials.

7. A method comprising:
generating an identity mapping database that maps a plurality of identities in a cloud computing environment to a single entity, wherein the identity mapping database is generated based on:
audit logs of actions between identities in the cloud computing environment,
resource properties fetched through an application programming interface for the cloud computing environment, and
hard-coded credentials located on cloud instances in the cloud computing environment; and
calculating a threat score for a first identity of the plurality of identities controlled by the single entity based on threat data for each one of the plurality of identities associated with the single entity in the identity mapping database.

8. The method of claim 7, further comprising storing threat data for the plurality of identities in an evidence table including one or more records, wherein each of the one or more records in the evidence table includes an identifier for one of the plurality of identities associated with a corresponding item of threat data in the record.

9. The method of claim 8, wherein each of the one or more records in the evidence table includes an expiration time after which the record is excluded from threat scoring for a corresponding one of the plurality of identities.

10. The method of claim 7, further comprising calculating the threat score as a joint probability of a first entity threat score for the first identity of the plurality of identities, and one or more other entity threat scores for each other one of the plurality of identities related to the first identity in the identity mapping database.

11. The method of claim 7, further comprising identifying the hard-coded credentials by scanning one or more files with a workload running on cloud instances in the cloud computing environment to locate hard-coded credentials in the one or more files for one or more of the plurality of identities.

12. The method of claim 11, wherein the workload includes an executable in a Windows environment.

13. The method of claim 11, wherein the workload includes a virtual machine, a serverless machine, or a container in a Linux environment.

14. The method of claim 7, wherein the identity mapping database includes one or more records, each of the one or more records including a time, a type, an actor identity, and an affected identity.

15. The method of claim 7, wherein an action between a pair of the identities detected based on the audit logs is stored in the identity mapping database as a record of an identity action event including a time of the action, a type of the action, a first one of the pair of identities causing the action, and a second one of the pair of identities affected by the action.

16. The method of claim 7, wherein a read event detected between a pair of identities based on user credentials in the resource properties is stored in the identity mapping database as a record of a credential read event including a time of the read event, a type of the read event, and a first one of the pair of identities initiating the read event, a second one of the pair of identities affected by the read event.

17. The method of claim 7, wherein a pair of the identities detected based on the hard-coded credentials is stored in the identity mapping database as a record including a time of discovery of the hard-coded credentials, a type of access by a workload detecting the hard-coded credentials, an actor identity having access to the workload, and an affected identity associated with the hard-coded credentials.

18. A system comprising:
a memory storing an identity mapping database for a cloud computing environment that includes a plurality of identities, wherein:
the identity mapping database identifies related identities, from among the plurality of identities, controlled by a single entity in the cloud computing environment,
one or more related identities in the identity mapping database are identified using audit logs for the cloud computing environment that provide information regarding an identity in the cloud computing environment that performed an action to create or affect another identity in the cloud computing environment,
one or more related identities in the identity mapping database are identified using an application programming interface for the cloud computing environment to fetch resource properties and scan the resource properties for user credentials, and
one or more related identities in the identity mapping database are identified by scanning files for hard-coded credentials with a workload running on cloud instances in the cloud computing environment; and
a threat detection module executing on a processor, the threat detection module configured by computer executable code to calculate a threat score for one of the plurality of identities based on threat data for one or more of the plurality of identities related to the one of the plurality of identities in the identity mapping database.

19. The system of claim 18, wherein the threat score is calculated as a joint probability of a first entity threat score for the one of the plurality of identities and one or more other entity threat scores for each of the one or more of the plurality of identities related to the one of the plurality of identities in the identity mapping database.

20. The system of claim 18, wherein each record in the identity mapping database includes a time, a type, an actor identity, and an affected identity.
